(19) United States
(12) Patent Application Publication
(10) Pub. No.: US 2024/0056366 A1
(43) Pub. Date: Feb. 15, 2024

(54) SYSTEMS AND METHODS FOR NETWORK CHANGES TO A COMPUTERIZED NETWORK

(71) Applicant: Rakuten Mobile, Inc., Tokyo (JP)

(72) Inventors: Satish Kumar BEHERA, Tokyo (JP); Zafar MANSURI, Madhya Pradesh (IN)

(21) Appl. No.: 17/762,738

(22) PCT Filed: Mar. 10, 2022
(86) PCT No.: PCT/US2022/019663

§ 371 Date: Mar. 23, 2022

(51) Int. Cl. H04L 41/22; H04L 41/0813; H04L 41/08; H04L 9/40

(52) U.S. Cl. CPC H04L 41/22; H04L 41/0813; H04L 41/0883; H04L 63/20

(57) ABSTRACT

System and methods of implementing changes on a computerized network are disclosed. In some embodiments, a RFC structure is generated that describes a change request for the computerized network. A target automated change request workflow is selected from a plurality of automated change request workflows based on the RFC structure. The target automated change request workflow is automatically implemented.

### BACKGROUND

A telecommunication network system includes network devices (such as switch, router, etc.) and other types of hardware. Some of this hardware implements software to perform network functions. In some cases, this hardware and software are proprietary or managed by specific vendors or contractors. Accordingly, when a network user wants to make a change in a network service, the user makes a change request to a network operator. The network operator has to review the request and obtain approval from responsible parties. The network operator then coordinates implementing the network changes with the technicians and engineers that make the actual changes. Managing changes in network systems is complex and challenging due to the amount of coordination and communications performed between different parties.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a computing system in accordance with some embodiments.

FIG. 2A-2O includes panels of a graphical user interface (GUI) used to generate a Request For Change (RFC) structure, in accordance with some embodiments.

FIG. 3 is a visual representation presented in the GUI of a RFC data structure, in accordance with some embodiments.

FIG. 4 is a visual representation of a workflow, in accordance with some embodiments.

FIG. 5 is a visual representation of a workflow, in accordance with some embodiments.

FIG. 6 is a visual representation of a workflow, in accordance with some embodiments.

FIG. 7 is a visual representation of a change implementation workflow, in accordance with some embodiments.

FIG. 8A is a panel of the GUI of a list of RFC structures, in accordance with some embodiments.

FIG. 8B is a panel of the GUI with a list of approvals related to a change request, in accordance with some embodiments.

FIG. 9 is a flowchart of a method of implementing changes on a computerized network, in accordance with some embodiments.

FIG. 10 is a flowchart of a method of generating the RFC structure, in accordance with some embodiments.

FIG. 11 is a flowchart that includes implementing the target automated change request workflow, in accordance with some embodiments.

FIG. 12 is a flowchart that includes implementing the target automated change request workflow, in accordance with some embodiments.

FIG. 13 is a flowchart that includes implementing the target automated change request workflow.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

(Optional, use when applicable) Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The disclosure includes systems and methods of automating approval and administration of network changes in a computerized network. Computerized networks include any type of network of computer devices where changes to the computerized network uses coordination of individuals to perform the network change. In some embodiments, the computerized networks include an Information Technology (IT) infrastructure and service network. In some embodiments, request for change (RFC) data structures are generated in order to describe change requests in an electronic form. In some embodiments, the RFC structures are generated through user inputs entered through a graphical user interface (GUI). The RFC structures are sent by the systems and methods disclosed herein to change approvers, change managers, and/or change executors so that the administration of the network change is performed in an automated fashion. To do this, a target automated change request workflow is selected from a plurality of automated change request workflows based on the RFC structure. When the system implements the target automated change request workflow, the notifications, approvals, authorizations, change result data, and/or test result data are obtained by the system to administer the change request.

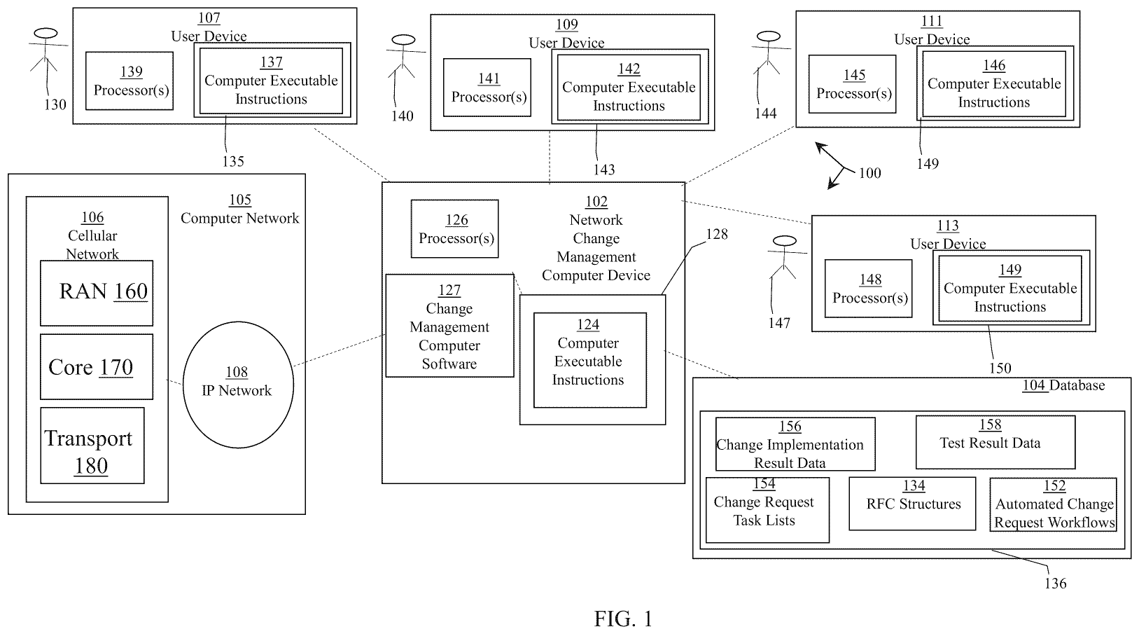

FIG. 1 is a block diagram of a computing system 100, in accordance with some embodiments.

The computing system 100 includes a network change management computer device 102, at least one database 104, a computer network 105, and user devices 107, 109, 111, 113. In FIG. 1, the computer network 105 includes a cellular network 106 and an internet protocol (IP) network 108. In some embodiments, the computer network 105 includes only an IP network 108. In some embodiments, the computer network 105 includes only the cellular network 106. In some embodiments, the computer network 105 includes multiple IP networks, like the IP network 108. In some embodiments, the computer network 105 includes multiple cellular networks, like the cellular network 106.

In some embodiments, the network change management computer device 102 and the cellular network 106 are connected to each other through the IP network 108. In some embodiments, the IP network 108 includes a wide area network (WAN) (i.e., the internet), a local area network (LAN), a wide area local area network (WLAN), and/or the like. In some embodiments, the cellular network 106 includes a wireless WAN (WWAN).

The cellular network 106 includes a radio access network (RAN) 160. The RAN 160 is the radio element of the cellular network 106. The RAN 160 includes network elements such as base stations that include one or more radio transceivers. The base stations cover land areas called cells. User equipment, such as cell phones, smartphones, laptops, etc., connect to each of the base stations that cover the cells. RAN 160 connects to the core 170 through back haul links, which are provided by the transport 180.

The core 170 is a central part of the overall cellular network 106. The core 170 allows mobile subscribers to get access to the services (e.g. international calling, text messaging, local cellular calls). In some embodiments, the core 170 is responsible for critical functions such as maintaining subscriber profile information, subscriber location, authentication of services, and the necessary switching functions for voice and data sessions. The core 170 includes network elements. In some embodiments, the network elements include a Mobility Management Entity (MME), a Serving Gateway, a Multimedia Broadcast Multicast Service (MBMS) Gateway, a Broadcast Multicast Service Center (BM-SC), and a Packet Data Network (PDN) Gateway. In some embodiments, the MME is in communication with a Home Subscriber Server (HSS). The MME is the control node that processes the signaling between the user equipment and the core 170. Generally, the MME provides bearer and connection management. In some embodiments, Internet protocol (IP) packets are transferred through a serving gateway, which itself is connected to the IP network 108.

The transport 180 refers to the transport network that connects the core 170 and the RAN 160 of the cellular network 106. The transport 180 includes network elements 182 such as backhaul links, connectors, relays, Voice over IP devices, etc. In some embodiments, the transport 180 includes a fronthaul that connects macrocell to the small cells, radio units, digital units and/or the like.

The network change management computer device 102 (server 102 in some embodiments) is a computer device that includes at least one processor 126 and a non-transitory computer readable medium 128. The non-transitory computer readable medium 128 stores computer executable instructions 124. In some embodiments, non-transitory computer readable medium 128 include a random-access memory (RAM), a read-only memory (ROM), an electrically erasable programmable ROM (EEPROM), optical disk storage, magnetic disk storage, other magnetic storage devices, combinations of the aforementioned types of computer-readable mediums, or any other medium that can be used to store computer executable code in the form of instructions or data structures that can be accessed by a computer device. When the processor 126 executes the computer executable instructions 124, the processor 126 executes the change management computer software 127.

The change management computer software 127 is configured to automate change request. In some embodiments, change requests relate to requested changes in hardware of the computer network 105. In some embodiments, change requests relate to requested changes in software of the computer network 105. In some embodiments, change requests relate to requested changes in both hardware and software of the computer network 105. In some embodiments, the hardware of network 105 comprises server, base station, radio unit, and/or any other suitable hardware in a network system, and the software of network 105 comprises a plurality of application performing telecommunication functions, managing the telecommunication performance, and/or any other suitable software in a network system. In some embodiments, the change management computer software 127 is configured to automate the approval process and/or implementation process used to get these changes done in the network 105.

For example, in some embodiments, change request actions are provided by a change requestor 130. The change requestor 130 is the user that is requesting a change in hardware and/or software in the computer network 105. As explained in further detail below, the change management computer software 127 receives user inputs from a user device 107 that is operated by the change requestor 130 in order to generate RFC structures 134. The change management computer software 127 stores the RFC structures 134 in the database 104. In some embodiments, database 104 stores the RFC structures 134 in the non-transitory computer readable medium 136.

The user device 107 includes a non-transitory computer readable medium 135 and at least one processor 139. The non-transitory computer readable medium 135 stores computer executable instructions 137. When the processor 139 executes the computer executable instructions 137, the user device 107 is configured to receive user inputs and send the user inputs to the change management computer software 127. Change management computer software 127 processes the user inputs and sends authorizations (which are provided by an external security system, etc., in some embodiments) to the user device 107.

The change requests are reviewed by a change manager 144. The change manager 144 is a user that is responsible for ensuring that the information in the change request is correct and that tasks associated with the change requests are performed in accordance to requirements and on schedule. As explained in further detail below, the change management computer software 127 receives user inputs from a user device 111 (that is operated by the change manager 144) in order to receive approvals and modification to the change requests. In some embodiments, the change management computer software 127 sends a notification (e.g., via email, SMS, push notification, etc.) of the change requests to a plurality of personnel qualified as change managers 114 to request at least one of the plurality of personnel to pick up/be in charge of the change requests. In some embodiments, once one of the plurality of personnel pick up/be in charge of the change request (e.g., by submitting a response to the notification of the change management computer software 127) the change management computer software 127 assigns the person as the change manager 114, and others of the plurality of personnel will not be able to pick up/be in charge of the change request without permission of the change manager 114. In some embodiments, change manager 144 modifies the change requests (e.g., modify the urgency level, execution schedule, and any other suitable fields of the change requests) by modifying the RFC structure 134. In some embodiments, change manager 144 reviews and approve the change requests without any modification. User device 111 of the change manager 144 requests that the change management computer software 127 send the RFC structure 134 (including modification/updates made by the change manager 114, if any) to user devices of all users associated with the role of approver. In some embodiments, before sending the RFC structure 134 to user devices of all users associated with the role approver, user device 111 of the change manager 144 requests that the change management computer software 127 send the modified change requests to the change requestor, to seek for the change requestor's agreement on the made modification.

The user device 111 includes a non-transitory computer readable medium 149 and at least one processor 145. The non-transitory computer readable medium 149 stores computer executable instructions 146. When the processor 145 executes the computer executable instructions 146, the user device 111 is configured to receive user inputs and send the user inputs to the change management computer software 127.

A change approver 140 approves the change requests. As explained in further detail below, the change management computer software 127 receives user inputs from a user device 109 (that is operated by the change approver 140) in order to receive authorizations for the change requests. User device 109 of the change approver 140 sends the authorizations or rejections for the RFC structure 134 (including updates in scheduling and classification, if any) to the change management computer software 127. In some embodiments, the approver (such as change approver 140) who is available at the time of receipt can accept to review the change request described by the RFC structure 134. Once an approver has accepted to review the change request, the approver will be assigned as the main approver of the change requests (other approvers can still review the change requests on behalf of the main approver, but the change management computer software 127 requests that the main approver to authorize/reject the change requests).

The user device 109 includes a non-transitory computer readable medium 143 and at least one processor 141. The non-transitory computer readable medium 143 stores computer executable instructions 142. When the processor 141 executes the computer executable instructions 142, the user device 109 is configured to receive user inputs and send the user inputs to the change management computer software 127.

In some embodiments, a change executor 147 executes the change requests. As explained in further detail below, the change management computer software 127 receives user inputs from a user device 113 (that is operated by the change executor 147) in order to receive success or failure messages for task items related to the change requests. In some embodiments, the change executor 147 implements network changes (i.e., software and/or hardware changes) through user inputs from the user device 113. User device 113 of the change executor 147 sends the success and/or failure messages for task items associated for the RFC structure 134.

When manual execution of the task item is to be implemented, the change executor 147 executes the change described in the task item. In some embodiments, the user device 113 includes a non-transitory computer readable medium 149 and at least one processor 148. The non-transitory computer readable medium 149 stores computer executable instructions 146. When the processor 145 executes the computer executable instructions 146, the user device 113 is configured to receive user inputs and send the user inputs to the change management computer software 127.

In some embodiments, the change requests are automatically executed by a change execution platform. The change execution platform is executed as part of the change management computer software 127 by the processor(s) 126. In some embodiments, the change execution platform is operated as software separate from the change management computer software 127 by the processor(s) 126. The processor(s) 126 of the change execution platform receives the RFC structures 134 of the change requests, executes the network changes, and sends success or failure messages for task items related to the change requests to the change management computer software 127.

The change management computer software 127 automates and coordinates the communication process and administration of change request for the computer network 105. As mentioned above, the change request are described in the computing system 100 by the RFC structures 134. In some embodiments, RFC structures 134 describe additions, modification and/or removal of approved, supported, and/or baselined hardware, network devices, software applications, environment changes, system architecture changes, desktop constructions, along with associated documentation.

The change management computer software 127 is configured to generate a RFC structure 134 that describes a change request for the computerized network 105. In some embodiments, the change management computer software 127 is configured to generate a graphical user interface (GUI) that is presented to the change requestor 130 through the user device 107. In some embodiments, the GUI presents selectable computer options that, when selected as user inputs, describe the change request by indicating the type of change, urgency level, risk level, impact, execution schedule, recommended task executors, and any other suitable parameters. Once the user inputs are received by the change management computer software 127, the change management computer software 127 is configured to produce the RFC structure 134. In some embodiments, the RFC structure 134 is presented to the change requestor 130 for reviewing and to receive from the change requestor 130 any changes to the data in the RFC structure 134.

Once the change management computer software 127 generates the RFC structure 134, the change management computer software 127 is configured to select a target automated change request workflow 152 from a plurality of automated change request workflows 152 based on the RFC structure 134. Automated change request workflows 152 are executables that automatically implement a workflow for implementing a change request or a portion of a change request. Different automated change request workflows 152 include different procedures depending on the data in the RFC structure 134. In some embodiments, automated change request workflows 152 include a standard change request workflow, a non-standard change request workflow, and an emergency change request workflow. In some embodiments, the approvers 140, the change managers 144, and/or the executors 147 that are to be involved in implementing the change requests are selected by the change management computer software 127 via the automated change request workflow 152. Different types of changes, urgency level, risk levels, network impacts, schedules, and/or change types result in the workflow involving different approvers 140, change managers 144, and executors 147 along with different procedures for implementing the network change in the change request.

In some embodiments, the standard change request workflow, the non-standard change request workflow, and the emergency change request workflow level are selected by the change management computer software 127 based on the urgency/importance of the change request. In some embodiments, the change requestor 130 specifies the level of urgency/importance. For example, the change requestor 130 enters user inputs into an input field in a graphical user interface (GUI) that indicates the level of urgency/importance, and based on the selected level, the change management computer software 127 automatically selects between the standard change request workflow, the non-standard change request workflow, and the emergency change request workflow level. Allowing the change requestor 130 to specify the level of urgency/importance provides flexibility to the change requestor 130. For example, the level of urgency/importance of a change request varies, in some embodiments, between different change requestors 130 depending on the functions performed by the change requestors 130 (e.g., a change request for increasing network capacity is less urgent for fault monitoring team, but very urgent for network engineering team, in some embodiments). In some embodiments, the change management computer software 127 automatically determines the level of urgency/importance of the change request based on keyword(s) correlation, based on the information related to the change requestor 130, and/or based on blast radius/impact radius of the change request.

Once the target automated change request workflow 152 is selected, the change management computer software 127 is configured to implement the target automated change request workflow 152. In some embodiments, the change management computer software 127 is configured to transmit the RFC structure 134 to the user device 109 of at least one change approver 140 associated with the selected automated change request workflow 152. In some embodiments, the change management computer software 127 is configured to send the RFC structure 134 to an approver 140 that is a domain approver. The domain approver includes system engineers, system programmers, and system operators that are responsible for a domain in the cellular network 105. The domain approver is presented with a visual representation of the RFC structure 134 to review the change request defined by the RFC structure 134. If the domain approver(s) approve of the change request described by the RFC structure 134, the domain approver(s) transmit an approval of the RFC structure 134 to the change management computer software 127. If the domain approver(s) do not approve of the change request described by the RFC structure 134, the domain approver(s) transmit a rejection of the RFC structure 134 to the change management computer software 127. In some embodiments, the domain approver is allowed to make changes to the RFC structure 134 or recommend changes to the change requestor 130 to revise/modify RFC structure 134 in order to approve the RFC structure 134.

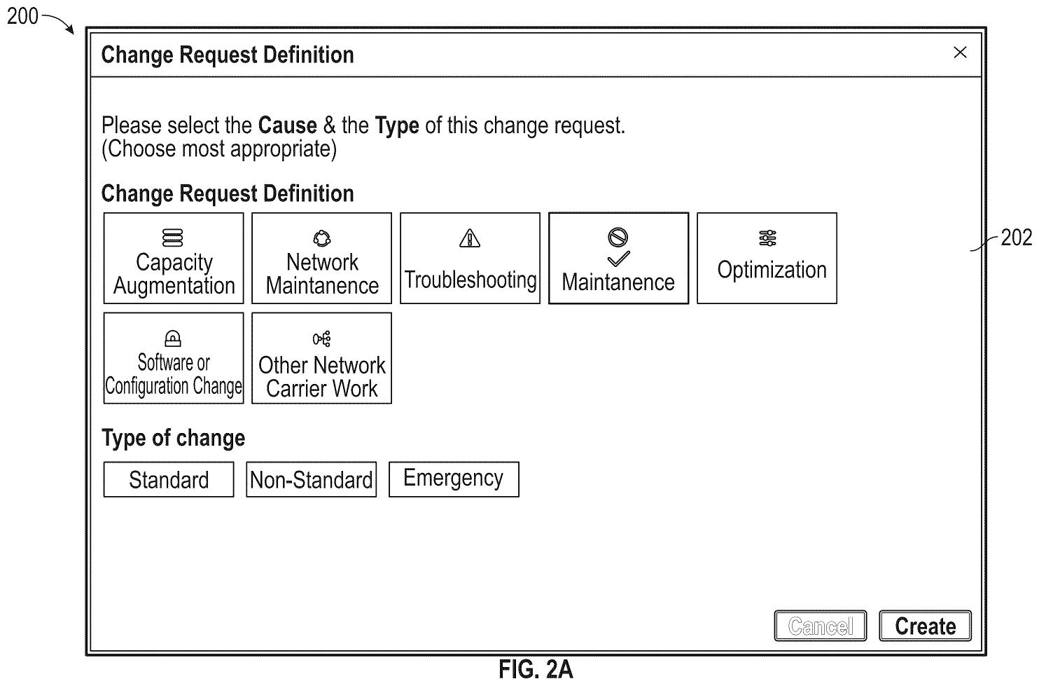

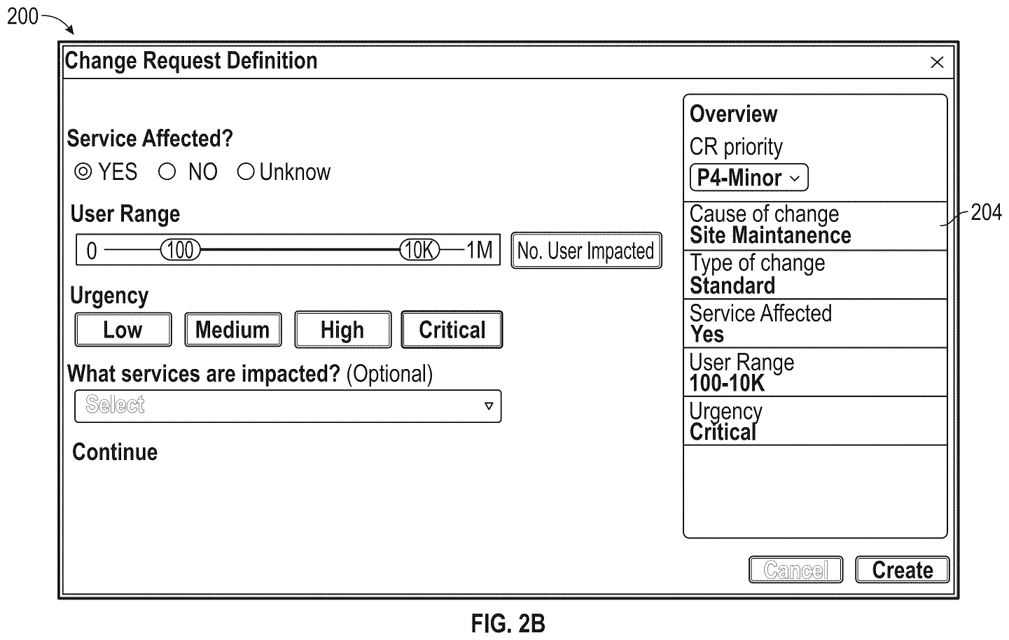

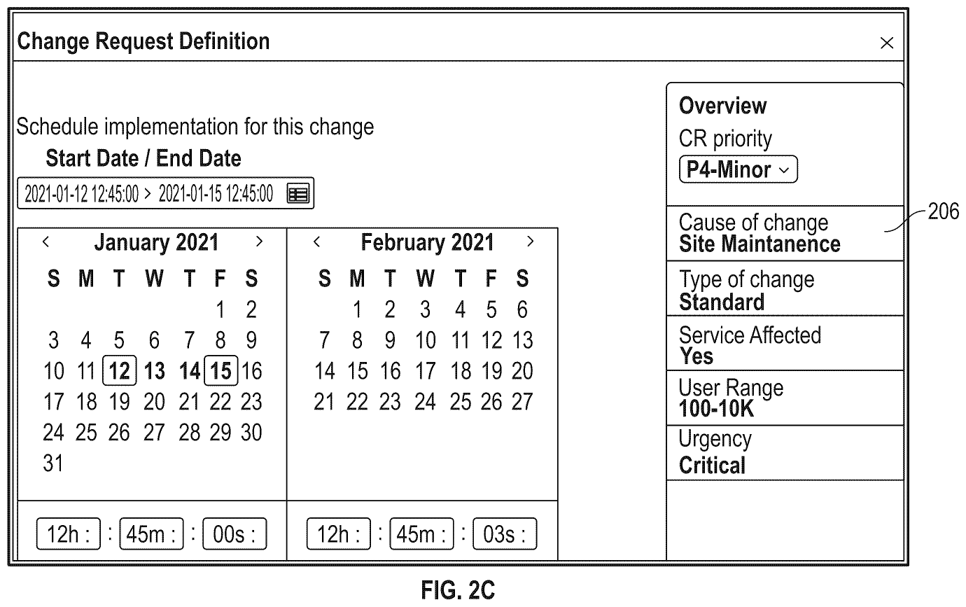

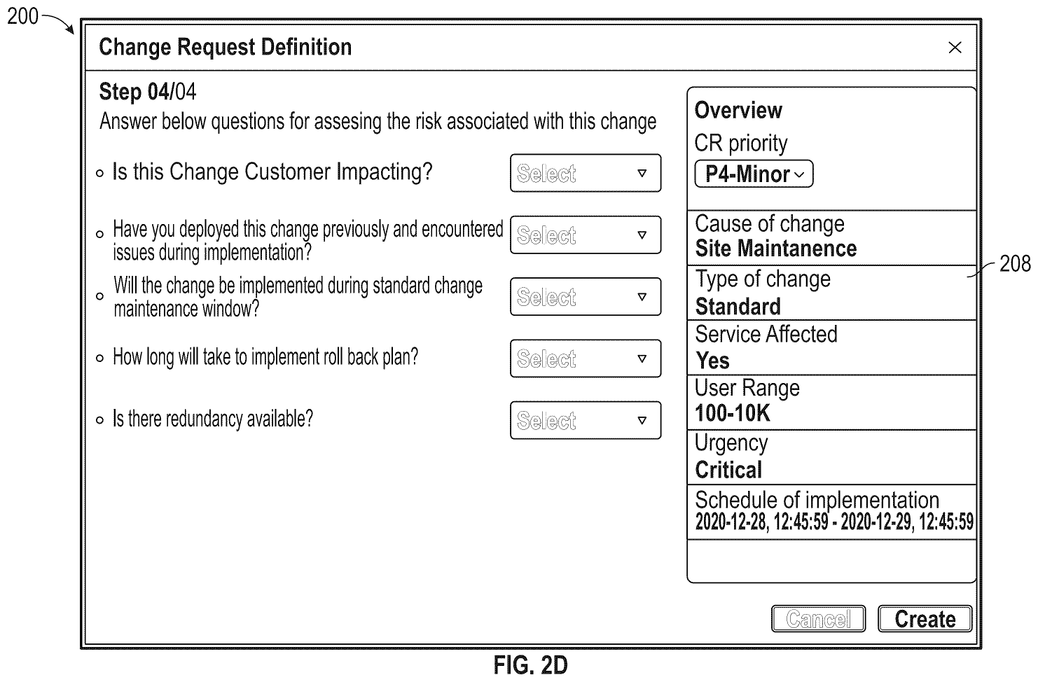

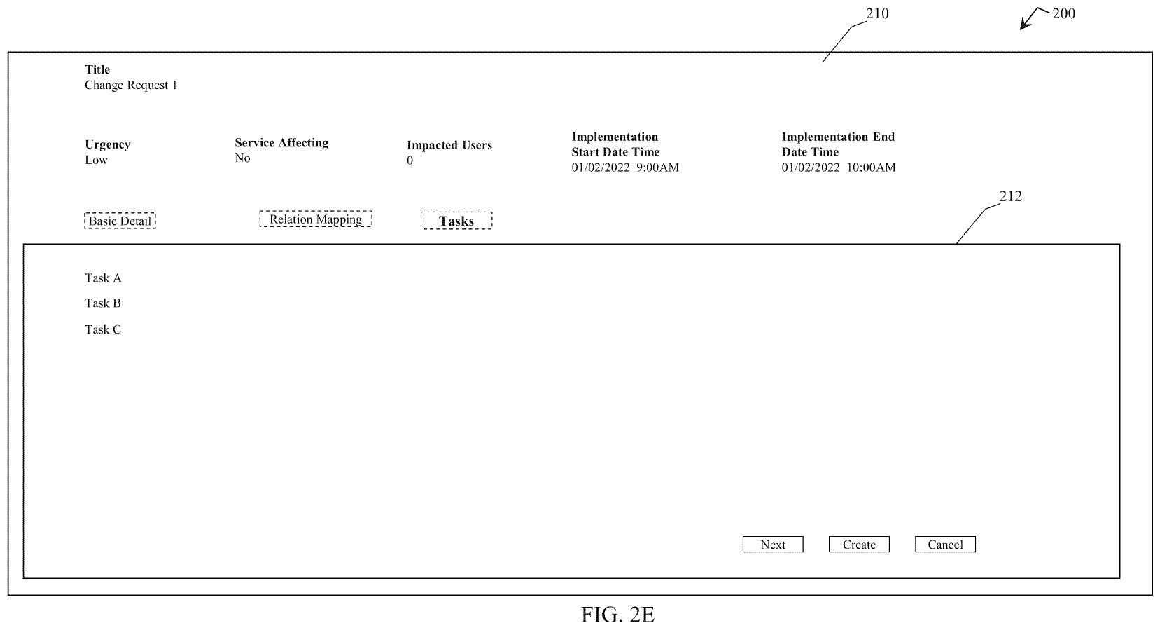

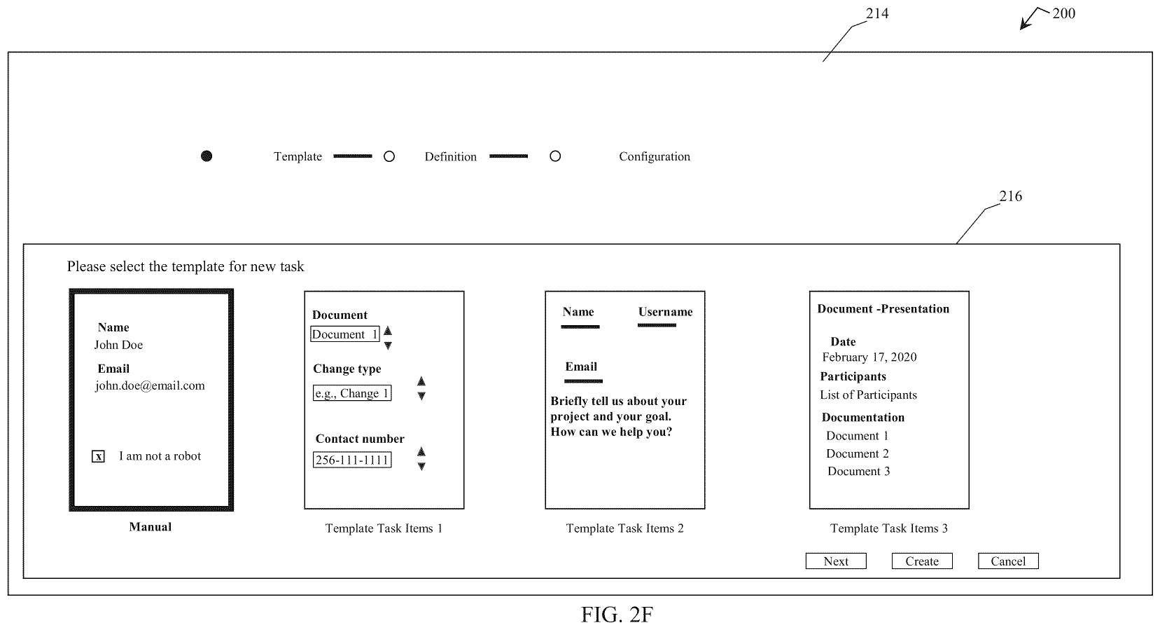

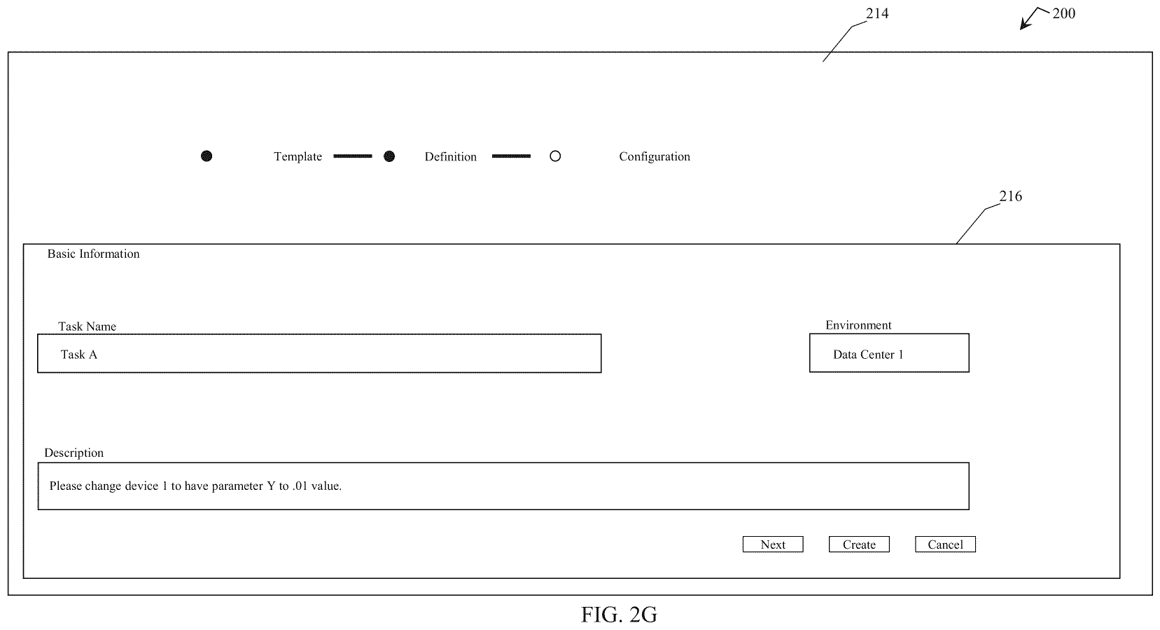

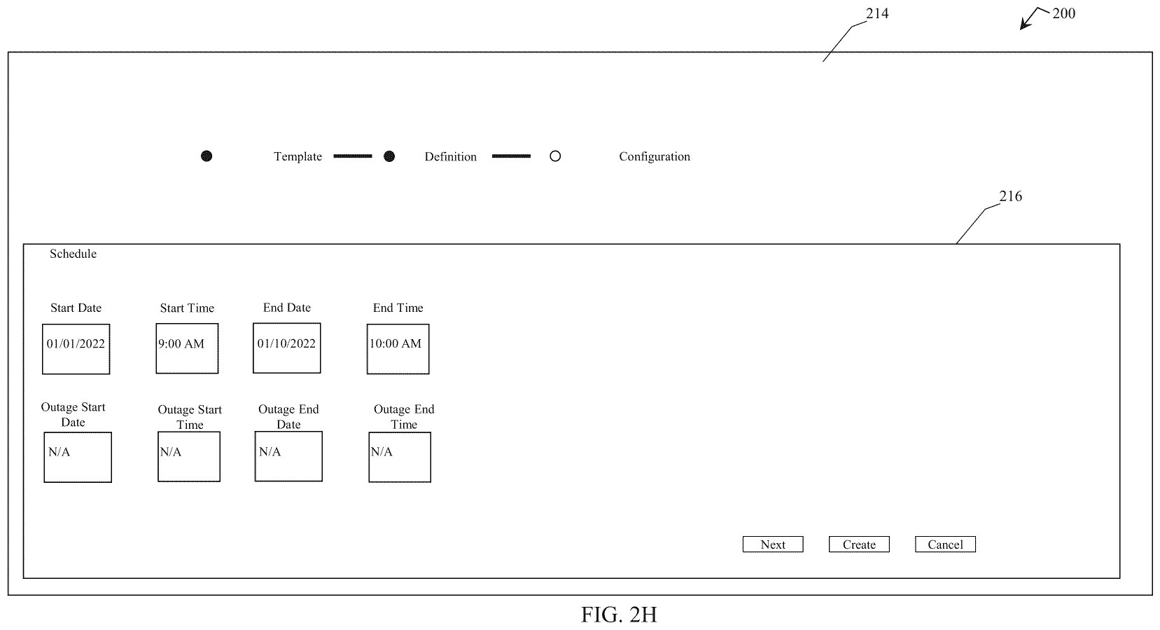

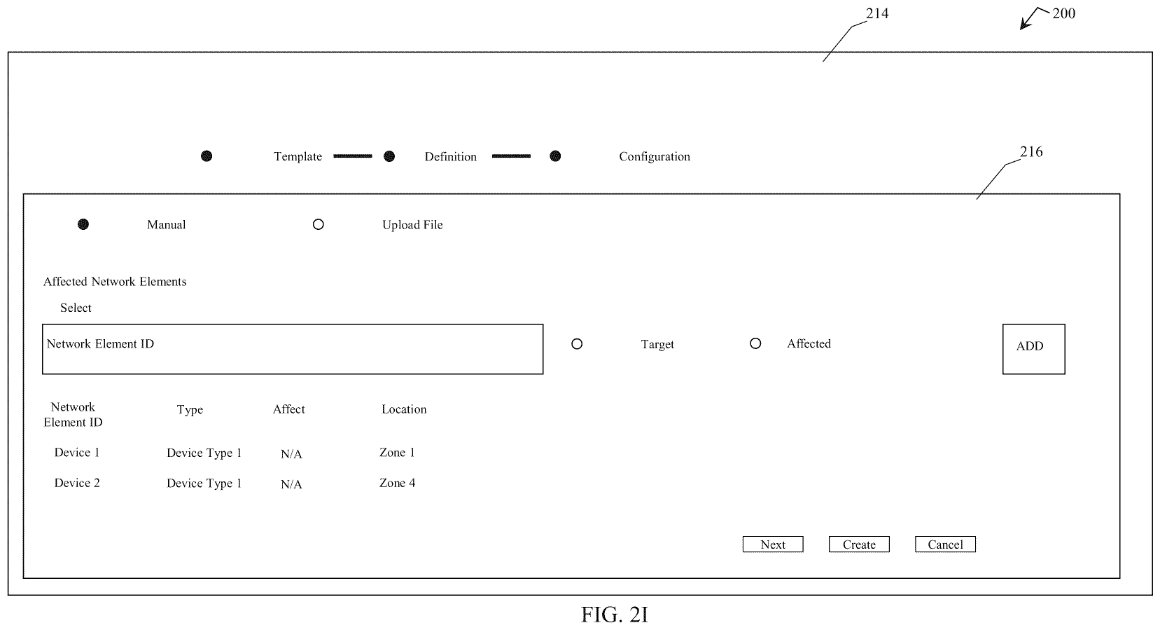

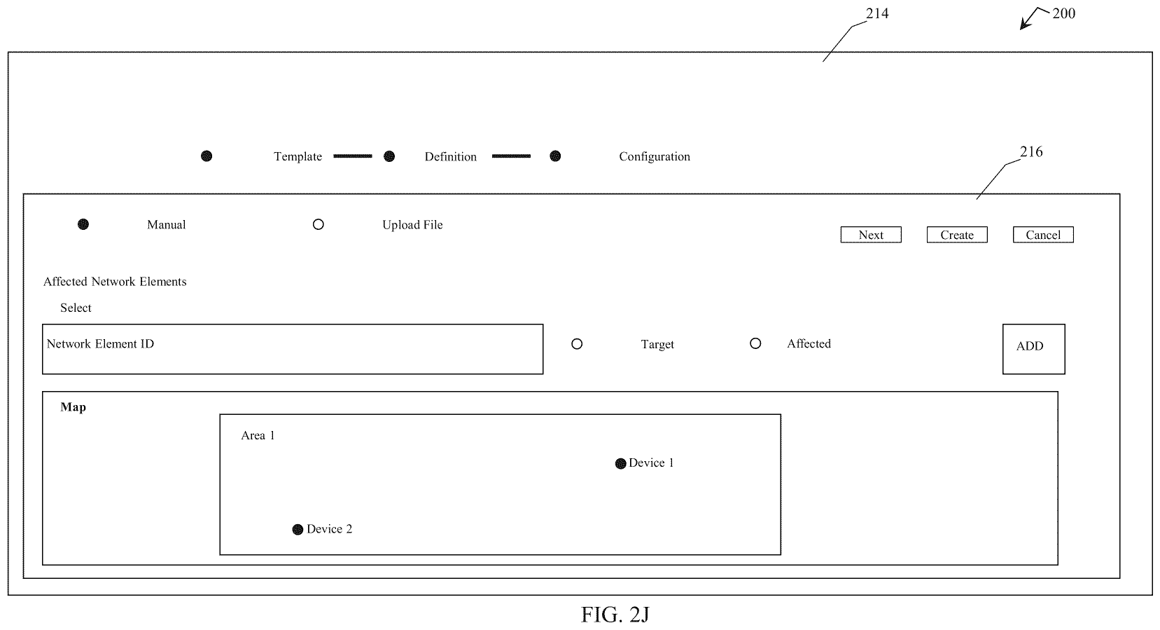

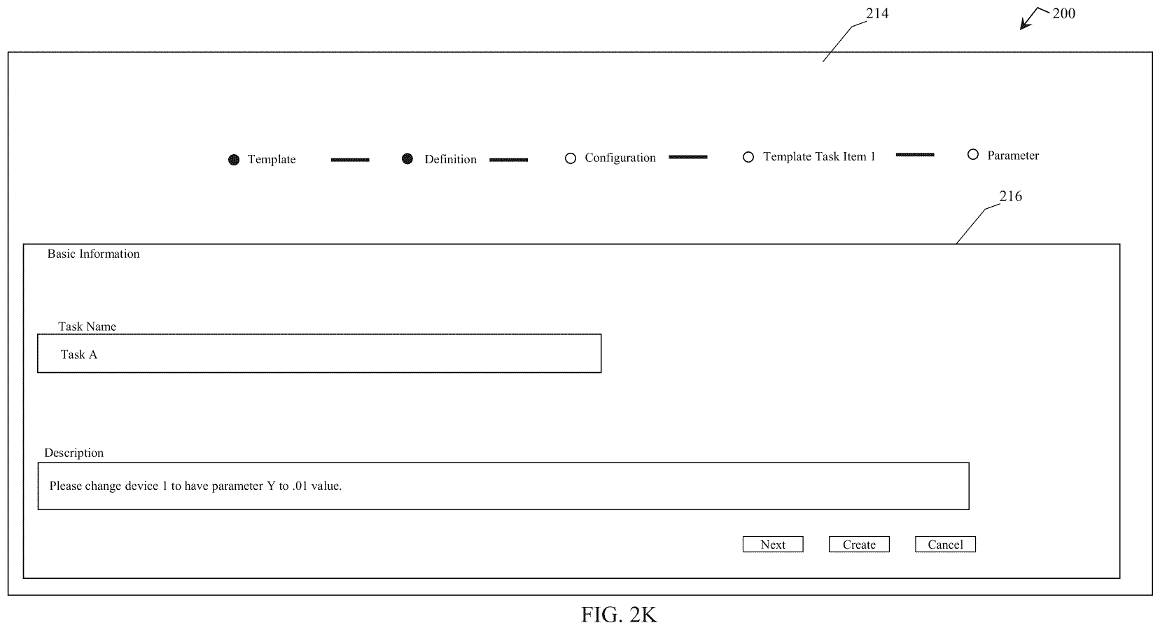

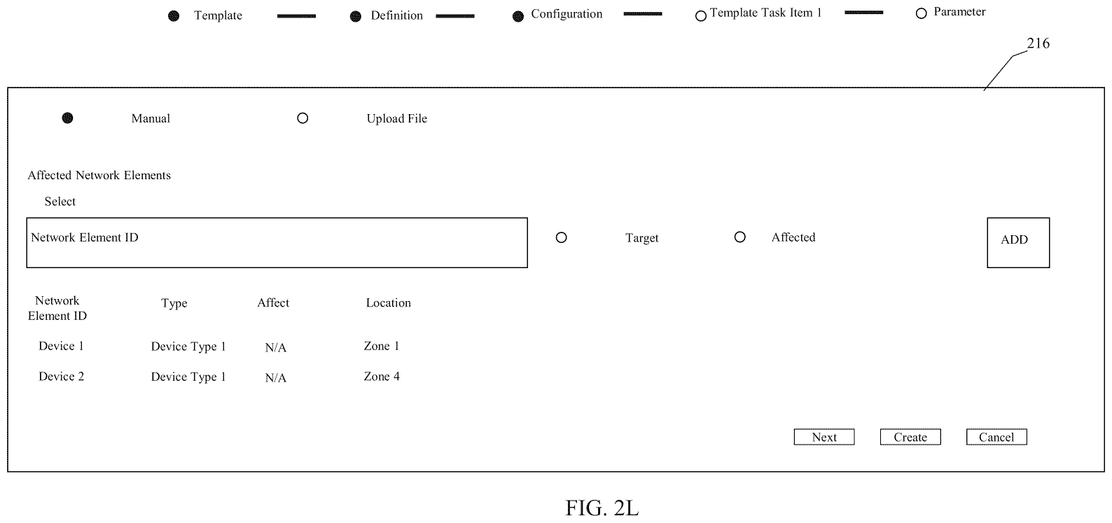

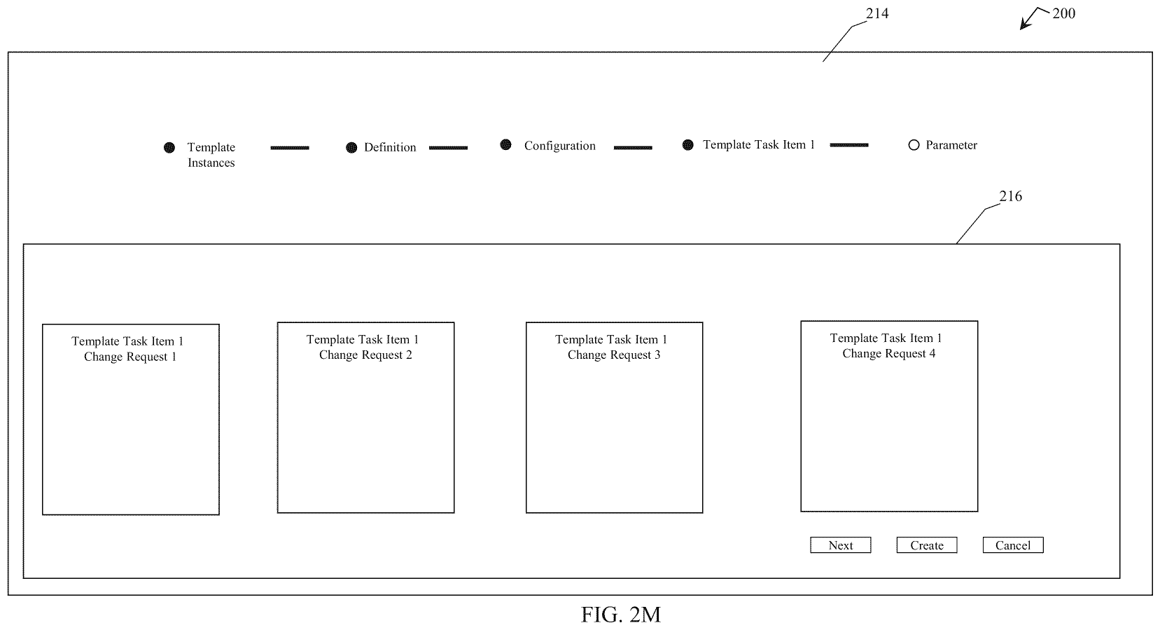

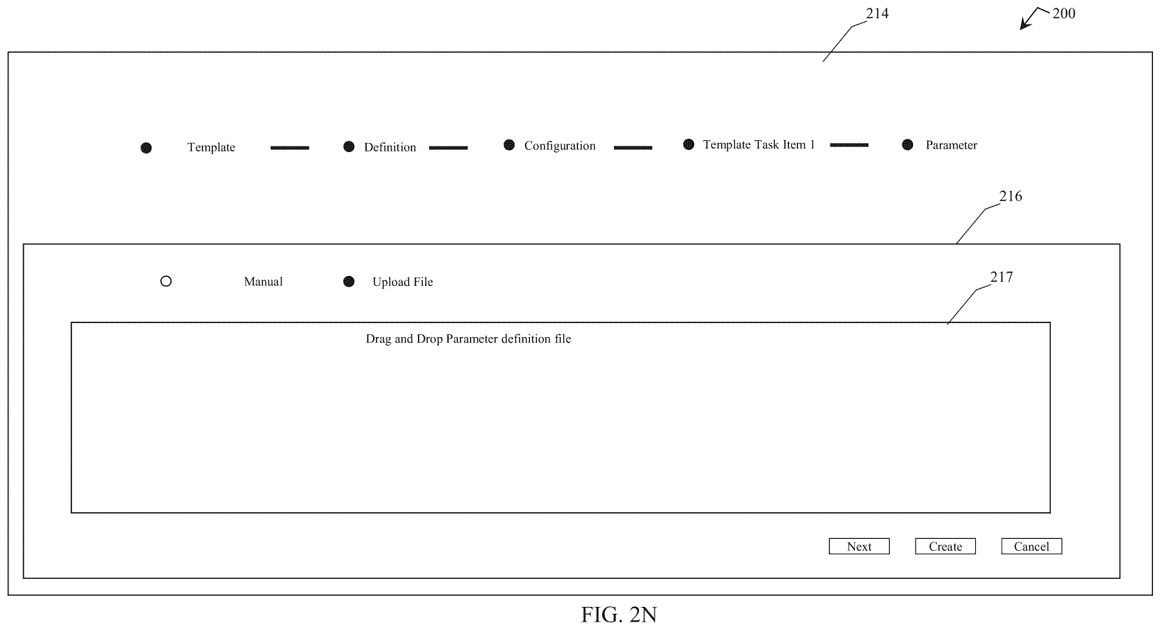

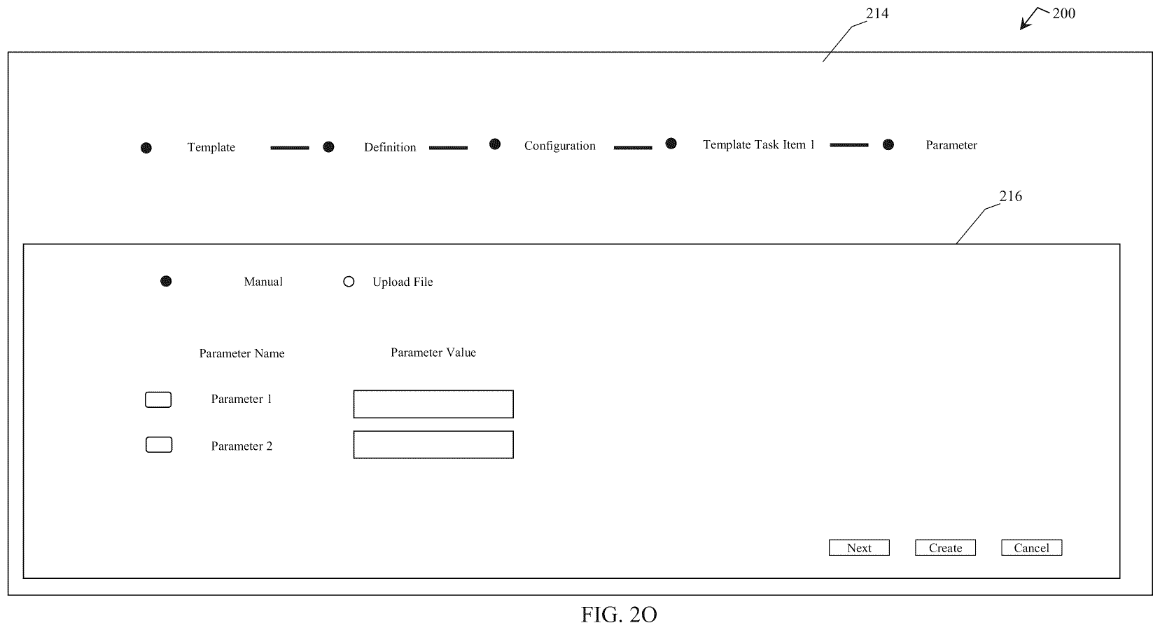

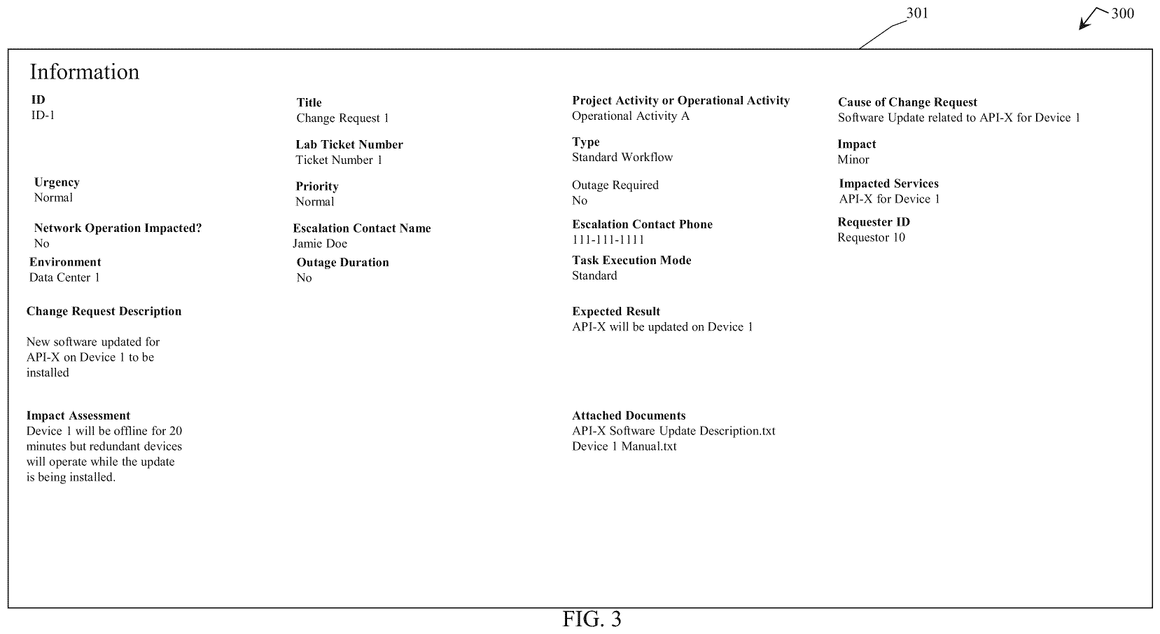

In some embodiments, the RFC structure 134 is initially sent to a change manager 144 prior to review by the domain approver. In some embodiments, the change manager 144 reviews a visual representation of the RFC structure 134 through a GUI presented on the user device 111. In some embodiments, the change manager 144 is responsible for reviewing the RFC structure 134 and scheduling the execution of the request for change described by the RFC structure 134. For example, if the scheduling for the request for change is performed manually rather than being automated, the change manager 144 coordinates with vendors to adjust execution timing and/or priority of the different tasks related to the request for change. The change manager 144 performs these tasks by providing user inputs through the GUI presented through the user device 111. An example of the GUI presented through the user device 111 is GUI 200 shown in FIGS. 2A-2O and FIG. 3. In some embodiments, the automated change request workflow 152 is initially sent to a change manager 144 prior to review by the domain approver. The change manager 144 will initially review the RFC structure 134 and/or the automated change request workflow 152. For example, the change manager 144 reviews the requested urgency level, request type, execution schedule, and approver/executor and determines whether the RFC structure 134 and/or the automated change request workflow 152 are appropriate. If not, the change manager 144 makes changes to the RFC structure 134 and/or selects another automated change request workflow 152. In some embodiments, the change manager 144 simply rejects the RFC structure 134 and/or the automated change request workflow 152. If the change manager 144 approves of the RFC structure 134, the change manager 144 provides user input indicating approval of the RFC structure 134 and/or the automated change request workflow 152 into the GUI.

In some embodiments, the RFC structure 134 is sent to the change manager 144 after the domain approver has made changes and/or approved the change request embodied by the RFC structure 134. The change manager 144 reviews the RFC structure 134. If the change manager 144 approves of the RFC structure 134, the change manager 144 provides user input indicating approval of the RFC structure 134 into the GUI. If not, the change manager 144 makes changes to the RFC structure 134. In some embodiments, the change manager 144 simply rejects the RFC structure 134.

In some embodiments, the change management computer software 127 is configured to send the RFC structure 134 to an approver 140 that is a security approver to review the change request defined by the RFC structure 134. The security approver includes security personnel that are responsible for security in the network 105. The security approver is presented with a visual representation of the RFC structure 134. If the security approver(s) approve of the change request described by the RFC structure 134, the security approver(s) transmit an approval of the RFC structure 134 to the change management computer software 127. If the security approver(s) do not approve of the change request described by the RFC structure 134, the security approver(s) transmit a rejection of the RFC structure 134 to the change management computer software 127. In some embodiments, the security approver is allowed to make changes to the RFC structure 134 or recommend changes to change requestor 130 to revise/modify the RFC structure 134 in order to approve the RFC structure 134.

In some embodiments, the RFC structure 134 is initially sent to a change manager 144 prior to review by the security approver. In some embodiments, the automated change request workflow 152 is initially sent to a change manager 144 prior to review by the security approver. The change manager 144 will initially review the RFC structure 134 and/or the automated change request workflow 152. For example, the change manager 144 reviews the requested urgency level, request type, execution schedule, and approver/executor and determines whether the RFC structure 134 and/or the automated change request workflow 152 are appropriate. If not, the change manager 144 makes changes to the RFC structure 134 and/or selects another automated change request workflow 152. In some embodiments, the change manager 144 simply rejects the RFC structure 134 and/or the automated change request workflow 152. If the change manager 144 approves of the RFC structure 134, the change manager 144 provides user input indicating approval of the RFC structure 134 and/or the automated change request workflow 152 into the GUI.

In some embodiments, the RFC structure 134 is sent to the change manager 144 after the security approver has made changes and/or approved the change request embodied by the RFC structure 134. The change manager 144 reviews the RFC structure 134. If the change manager 144 approves of the RFC structure 134, the change manager 144 provides user input indicating approval of the RFC structure 134 into the GUI. If not, the change manager 144 makes changes to the RFC structure 134. In some embodiments, the change manager 144 simply rejects the RFC structure 134.

In some embodiments, the change management computer software 127 is configured to send the RFC structure 134 to an approver 140 that is a Service Experience Center (SXC) approver. The SXC approver is in charge of checking whether or not the requested change has any negative impacts on the operation of the network 105 or conflict with any of the operations of the network 105. The SXC approver is presented with a visual representation of the RFC structure 134 to review the change request defined by the RFC structure 134. If the SXC approver(s) approve of the change request described by the RFC structure 134, the SXC approver(s) transmit an approval of the RFC structure 134 to the change management computer software 127. If the SXC approver(s) do not approve of the change request described by the RFC structure 134, the SXC approver(s) transmit a rejection of the RFC structure 134 to the change management computer software 127. In some embodiments, the SXC approver is allowed to make changes to the RFC structure 134 or recommend changes to change requestor 130 to revise/modify the RFC structure 134 in order to approve the RFC structure 134.

In some embodiments, the RFC structure 134 is initially sent to a change manager 144 prior to review by the SXC approver. In some embodiments, the automated change request workflow 152 is initially sent to a change manager 144 prior to review by the SXC approver. The change manager 144 will initially review the RFC structure 134 and/or the automated change request workflow 152. For example, the change manager 144 reviews the requested urgency level, request type, execution schedule, and approver/executor and determines whether the RFC structure 134 and/or the automated change request workflow 152 are appropriate. If not, the change manager 144 makes changes to the RFC structure 134 and/or selects another automated change request workflow 152. In some embodiments, the change manager 144 simply rejects the RFC structure 134 and/or the automated change request workflow 152. If the change manager 144 approves of the RFC structure 134, the change manager 144 provides user input indicating approval of the RFC structure 134 and/or the automated change request workflow 152 into the GUI.

In some embodiments, the RFC structure 134 is sent to the change manager 144 after the SXC approver has made changes and/or approved the change request embodied by the RFC structure 134. The change manager 144 reviews the RFC structure 134. If the change manager 144 approves of the RFC structure 134, the change manager 144 provides user input indicating approval of the RFC structure 134 into the GUI. If not, the change manager 144 makes changes to the RFC structure 134. In some embodiments, the change manager 144 simply rejects the RFC structure 134.

Once the appropriate approvers 140 have approved the change request described by the RFC structure 134, the change management computer software 127 is configured to transmit the RFC structure 134 to the user device 111 of the change manager 144. In some embodiments, the RFC structure 134 is sent to the user device 111 of the change manager 144 every time or some of the times that an approver approves of the change request, as described above.

In some embodiments, the change management computer software 127 generates an change request task list 154. The change request task list 154 describes the different tasks that are to be performed by the change executors 147 to implement the change request on the network 105. Thus, the automated change management task lists 154 includes one or more task items for implementing the change request described by the RFC structure 134. In some embodiments, the change manager 144 is configured provide user inputs that change, approve, or reject the tasks list. The change management computer software 127 is configured to schedule the task items on the change request task list 154 for the change request described in the RFC structure 134. In some embodiments, the change manager enters in manual user inputs to schedule the task items. In other embodiments, the change management computer software 127 automatically schedules the task items based on the RFC structure 134. The change manager 144 is then configured to provide user inputs that authorizes the change request described by the RFC structure 134. In some embodiments, the change management computer software 127 automatically sends notifications to the change manager 144 in response to status updates from the user devices 113 of change executors 147 regarding the task items (e.g., completed, incomplete, success, failure). In some embodiments, the change management computer software 127 automatically sends notifications to the change manager 144 in response to the task items not being completed in accordance to schedule. In some embodiments, the change management computer software 127 automatically sends notifications to the user devices 113 of other change executors 147 in response to the task items not being completed in accordance to the schedule. In some embodiments, the change management computer software 127 automatically updates schedules for task items and sends notifications to the user devices 113 of other change executors 147 in response to the task items not being completed in accordance to the schedule. In some embodiments, the scheduling of the task items in the change request task list 154 is performed through a change execution platform.

In some embodiments, once the change manager 144 authorizes the change requests, the change management computer software 127 transmits notifications of scheduled task items to the user devices 113 of the change executors 147 and/or to a change execution platform. In some embodiments, the change executors 147 and/or to the change execution platform implement the tasks described by the task items using the change management computer software 127. In some embodiments, the change executors 147 and/or to the change execution platform implement the network changes to the computer network 105 described by the task items independently of the change management computer software 127. In some embodiments, the change executors 147 and/or to the change execution platform implement software changes to the computer network 105. In some embodiments, the change executors 147 and/or the change execution platform implement hardware changes and/or software changes to the computer network 105. The change executors 147, through the user devices 113, and/or to the change execution platform, transmit change implementation result data 156 to the change management computer software 127. The change implementation result data 156 identifies whether one or more task items on the change request task list 154 was completed (e.g., successfully and fully executed) or was incomplete (e.g., an execution failure or partially executed).

FIG. 2A is a GUI 200 that includes a panel 202 used to generate a RFC structure, in accordance with some embodiments.

In some embodiments, the change management computer software 127 is configured to generate the GUI 200, including the panel 202, which is presented to the change requestor 130 through the user device 107 (See FIG. 1).

In some embodiments, the panel 202 includes selectable items that describe the cause of a network change for the change request. In FIG. 2A, the selectable items are for “Capacity Augmentation,” “Network Maintenance,” “Troubleshooting,” “Site Maintenance,” “Optimization,” “Software or Configuration Change,” or “Other Network Carrier Work.” The “Capacity Augmentation” selectable item is selected when additional hardware and/or software is being added to the network 105 (See FIG. 1). The “Network Maintenance” is when maintenance is to be performed on the network 105. The “Troubleshooting” selectable item is selected when the functionality of a network element is to be examined and/or fixed. The “Site Maintenance” selectable item is selected when a maintenance on a portion of the network 105 is to be performed. The “Optimization” selectable item is selected when a portion of the network 105 is to be optimized. The “Software or Configuration Change” selectable item is selected when software is to be changed (e.g., added, reduced, modified, etc.) or when hardware is being reconfigured in the network 105. “Other Network Carrier Work” selectable item is selected when miscellaneous network changes are being made to a portion the network 105. In at least one example, the “Site Maintenance” selectable item has been selected.

The panel 202 also includes selectable items for the type of change. The type of change includes selectable items for “Standard,” “Non-Standard,” and “Emergency.” In some embodiments, the panel 202 includes selectable items for more type of changes (e.g., could be pre-defined type such as “Level 2 Emergency” or defined by the change requestor such as “emergency change for project X”, etc.) or less type of change as illustrated in FIG. 2A. In some embodiments, these selectable items select the broadest categories of an automated workflow. When the “Standard” selectable item is selected, a workflow is selected for automatic implementation for standard network changes. When the “Non-Standard” selectable item is selected, a workflow is selected for automatic implementation of non-standard network changes. When the “Emergency” selectable item is selected, a workflow is selected for automatic implementation of emergency network changes.

FIG. 2B is the GUI 200 that includes a panel 204 used to generate a RFC structure, in accordance with some embodiments.

In some embodiments, the change management computer software 127 is configured to generate the GUI 200, including the panel 204, which is presented to the change requestor 130 through the user device 107.

In FIG. 2B, panel 204 includes a selectable option regarding whether “Service is Affected?” The change requestor 130 (See FIG. 1) selects Yes, No or Unknown.

The panel 204 includes a selectable option where the change requestor enters a range estimate regarding the number of user that are affected by the network change. In some embodiments, said selectable option is a sliding bar and an input window (as shown in FIG. 2B). In some embodiments, said selectable option is a drop-down list (not shown), or can be any suitable options for receiving user's input for specifying the user range.

The panel 204 includes a selectable option that indicate the urgency level of the change request. In some embodiments, the selectable options include selectable button such as “Low,” “Medium,” “High,” “Critical.”, as shown in FIG. 2B. In some embodiments, said selectable option is a sliding bar, a drop-down list (not shown), or can be any suitable options for receiving user's input for specifying the urgency level.

In some embodiments, panel 204 includes a selectable option that allows the change requestor 130 to indicate what services, devices, and/or users in the network 105 will be impacted by the requested changes. In some embodiments, said selectable option includes a drop-down list or pulldown bar (e.g., illustrated as “What services are impacted?” in FIG. 2B). In some embodiments, said selectable option is a drop-down list (not shown) which includes possible services, devices, and/or users in the network 105 will be impacted, or can be any suitable options for receiving user's input for specifying the services, devices, and/or users in the network 105 will be impacted.

In an Overview section of the panel 204, the panel 204 displays a summary of essential fields of the change request defined by the selections made by the charge requestor 130. Furthermore, the Overview section includes a pulldown bar/drop-down list with selectable options where the change requestor 130 selects the priority level of the change request. In FIG. 2B, the charge requestor 130 has selected “Minor” as the priority level of the change request.

FIG. 2C is the GUI 200 that includes a panel 206 used to generate a RFC structure, in accordance with some embodiments.

In FIG. 2C, panel 206 includes a selectable option that allow the change requestor to specify the execution timeline of the requested change. In some embodiments, said selectable option includes virtual calendars which allow the change requestor 130 to select the execution starting and ending time timeline (e.g., dates and time) for the requested change. In some embodiments, said selectable option includes other suitable options for receiving the user's input for specifying the execution starting and ending time timeline for the requested change, such as an input window, a drop-down list, and the like.

FIG. 2D is the GUI 200 that includes a panel 208 used to generate a RFC structure, in accordance with some embodiments.

In FIG. 2D, the panel 208 includes various drop-down list/pull-down menus with selectable options.

One of the drop-down lists/pull-down menus includes options (illustrated as “Is this Change Customer Impacting?” in FIG. 2D) for allowing the change requestor 130 to select whether the change impacts any customer. In some embodiments, the options include “Yes”, “No”, and “Unknown”. In some embodiments, the options include more detailed selectable options, such as “Yes—Level 1 Impact”, “Yes—Level 2 Impact”, and the like, to allow the user to more specifically specify the customer impact.

One of the drop-down lists/pull-down menus includes options (illustrated as “Have you deployed this change previously and encountered issues during implementation?” in FIG. 2D) that describes whether there where issues previously with implementing the same change. In some embodiments, the options include “Yes”, “No”, “Not available”, and “Unknown.” In some embodiments, the options include more detailed selectable options, such as “Yes—Last Month”, “Yes—Within the Last Year”, and the like, to allow the user to more specifically describe a time range when the same change was previously deployed and/or issues were previously encountered.

One of the drop-down lists/pull-down menus includes options (illustrated as “Will the change be implemented during standard change maintenance window?” in FIG. 2D) where the change requestor 130 selects whether the change is to-be implemented during a standard change window. In some embodiments, the options include “Yes”, “No”, “Not available” and “Unknown”.

One of the drop-down lists/pull-down menus includes options (illustrated as “How long will it take to implement roll back plan?” in FIG. 2D) where the change requestor 130 enters an amount of time for reconfiguring the cellular network 105 back to how the cellular network 105 was before the change request was implemented. One of the drop-down lists/pull-down menus includes options (illustrated as “Is there redundancy available?” in FIG. 2D) where the change requestor 130 selects whether there are redundant systems available for maintaining the computer network 105 while the network change is being implemented. In some embodiments, the options include “Yes”, “No”, “Not Available”, and “Unknown.” In some embodiments, the options include more detailed selectable options, such as “Yes—Device A”, “Yes—Device B”, and the like, to allow the user to more specifically select a redundant device.

FIG. 2E is the GUI 200 that includes a panel 210 used to describe task items for a change request, in accordance with some embodiments.

The panel 210 visually illustrates various data fields including, but not limiting to, a change request title (i.e., “Title” in FIG. 2E), an urgency identifier (i.e., “Urgency” in FIG. 2E), an identifier indicating whether network service is to be affected (i.e., “Service Affecting” in FIG. 2E), a field that identifies the number or a range of network users affected by the change request (i.e., “Impacted Users” in FIG. 2E), a field that indicates a date and time that a task item began (i.e., “Implementation Start Date Time” in FIG. 2E), and a field that indicates a date and time that a task item is completed (i.e., “Implementation End Date Time” in FIG. 2E). The panel 210 includes a subpanel 212. The subpanel 212 is configured to illustrate the details regarding a change request (i.e., “Basic Details in FIG. 2E), illustrate relationships between different task items in a change request (i.e., “Relation Mapping” in FIG. 2E), and illustrate different task items for a change request (i.e., “Tasks” in FIG. 2E). User input is received from the user so that the subpanel 212 presents any of the three options.

More specifically, in some embodiments, the illustrated text “Basic Details” is selectable by the user so that basic information regarding the request for change is presented in panel 212. In some embodiments, the illustrated text “Basic Details” is selectable by clicking a pointer controlled by a mouse. In some embodiments, the illustrated text “Relation Mapping” is selectable by the user so that relationship between different requests for changes (e.g., the relationship between the current request and previous request, the relationship between the current request and request ID of other requests, etc.) are illustrated in the panel 212. In some embodiments, the illustrated text “Relation Mapping” is selectable by clicking a pointer controlled by a mouse. In some embodiments, the illustrated text “Tasks” is selectable by the user so that relationship between different requests for changes are illustrated in the panel 212. In some embodiments, the illustrated text “Tasks” is selectable by clicking a pointer controlled by a mouse. In the example shown in FIG. 2E, exemplary tasks are being shown for the current request for change.

In FIG. 2E, buttons named “next” is selectable by a user to move on to the next panel in the GUI 200. A button named “create” is provided to create a new task. A button named “Cancel” is provided so that a user can cancel any undesired selections.

FIG. 2F is the GUI 200 that includes a panel 214 used to create task items, where a template option is selected in accordance with some embodiments.

The panel 214 visually illustrates a template option (i.e., “Template” in FIG. 2F), a definition option (i.e., “Definition” in FIG. 2F), and a configuration option (i.e., “Configuration” in FIG. 2F). In some embodiments, the template option, the definition option, and the configuration option are sequential. For example, the user provides user input for the template option first. Once the user enters user input for the template option, the user is presented with the definition option. Once the user provides user input for the definition option, the user is presented with the configuration option. The user then provides user input for the configuration option.

In FIG. 2F, various template options are presented in a subpanel 216 of the panel 214. User input is received so that the user selects between a manual task option (i.e., “Manual” in FIG. 2F) or between various template tasks options (i.e., “Template Task Items 1,” “Template Task Items 2,” and “Template Task Items 3” in FIG. 2F). In some embodiments, the various template tasks options comprise automatic task option, semi-automatic task options, or any suitable types of task option. If user input is received to select the manual task option, the user is permitted to create tasks for a particular change request manually. The various template tasks options each have one or more predefined tasks. The task items defined by a selected template tasks option are automatically assigned to the RFC structure 134 in response to one of the template tasks options being selected.

In FIG. 2F, buttons named “next” is selectable by a user to move on to the next panel in the GUI 200. A button named “create” is provided to create a new task using the selected template. A button named “Cancel” is provided so that a user can cancel any undesired selections.

FIG. 2G is the GUI 200 that includes the panel 214 used to create task items, where a definition option is presented after the presentation of the template option and basic information options are shown in accordance with some embodiments.

In FIG. 2G, subpanel 216 is configured to allow the user to enter in user input related to basic information for a new task for manual definition of the task item.

A text bar named “Task Name” is provided that allows a user to enter text for the name of the task item. A text bar named “Environment” is provided that allows a user to enter text for the environment of the task item. In the text bar named “Environment”, user text is received describing the location of the data center. A text bar named “Description” is provided that allows a user to enter text for a description of the task item.

In FIG. 2G, buttons named “next” is selectable by a user to move on to the next panel in the GUI 200. A button named “create” is provided to create a new task. A button named “Cancel” is provided so that a user can cancel any undesired selections.

FIG. 2H is the GUI 200 that includes the panel 214 used to create task items, where a definition option is presented after user input regarding the definition option has been received and scheduling options are shown in accordance with some embodiments.

In FIG. 2H, subpanel 216 is configured to allow the user to enter in user input related to scheduling for the task.

A scheduling menu is configured to allow a user to enter user input related to a start date for the task item (i.e., “Start Date” in FIG. 2H). A scheduling menu is configured to allow a user to enter user input related to a start time for the task item (i.e., “Start Time” in FIG. 2H). A scheduling menu is configured to allow a user to enter user input related to an end date for the task item (i.e., “End Date” in FIG. 2H). A scheduling menu is configured to allow a user to enter user input related to an end time for the task item (i.e., “End Time” in FIG. 2H).

In some embodiments, the task item involves an outage in the network. If no outage is to occur, then relevant fields appear with N/A. In some embodiments, a scheduling menu is configured to allow a user to enter user input related to an outage start date for the task item (i.e., “Outage Start Date” in FIG. 2H). A scheduling menu is configured to allow a user to enter user input related to an outage start time for the task item (i.e., “Outage Start Time” in FIG. 2H). A scheduling menu is configured to allow a user to enter user input related to an outage end date for the task item (i.e., “Outage End Date” in FIG. 2H). A scheduling menu is configured to allow a user to enter user input related to an outage end time for the task item (i.e., “Outage End Time” in FIG. 2H).

In FIG. 2H, buttons named “next” is selectable by a user to move on to the next panel in the GUI 200. A button named “create” is provided to schedule a new task. A button named “Cancel” is provided so that a user can cancel any undesired selections.

FIG. 2I is the GUI 200 that includes the panel 214 used to create task items, where devices related to the task are selectable as shown in accordance with some embodiments.

In FIG. 2I, the configuration option is shown after user input for the definition option is received. Subpanel 216 is configured to allow the user to enter devices related to the task item.

In FIG. 2I, a manual option and an upload file option are configured to define devices related with the task item. If the upload file option is selected, then a user is allowed to upload a file that defines the device that is affected by the task item. If the manual option is selected (as shown in FIG. 2I), the user inputs or selects a Network Element ID into a search bar. Further, a target option (i.e., “Target” in FIG. 2I) and an affected option (i.e., “Affected” in FIG. 2I) allow the user to identify whether the device is the target of the task item or whether the device simply is affected by the task item. Once the user has selected the desired network element and specified whether the selected network element is the target of the task item or is simply affected by the task item, the user selects an interactive element (e.g., an “Add” button as illustrated in FIG. 2I) to add the network element to a list presented within the subpanel 216. In some embodiments, when the manual option is selected (as shown in FIG. 2I), the user inputs or selects a keyword associated with the desired devices (e.g., a keyword associated with a device type, a device location, a device labeling, etc.) into a search bar, and the system will present network elements related to the keyword in the list presented within the subpanel 216. Subsequently, the user can select one or more desired network elements from the list. The list provides a network element ID (i.e., “Network Element ID” in FIG. 2I), an identifier that identifies a device type (i.e., “Type” in FIG. 2I), an identifier that identifies an affected area by the device (i.e., “Affected” in FIG. 2I), and an identifier that identifies a location of the device (i.e., “Location” in FIG. 2I). In some embodiments, if the upload file option is selected and the user uploads a file to the system, the system processes the file to retrieve the associated information and present such information in list shown in the subpanel 216.

In FIG. 2I, buttons named “next” is selectable by a user to move on to the next panel in the GUI 200. A button named “create” is provided to include new devices related to the task. A button named “Cancel” is provided so that a user can cancel any undesired selections.

FIG. 2J is the configuration option shown after user input for the definition option is received. Subpanel 216 is configured to allow the user to select devices related to the task item. Subpanel 216 in FIG. 2J is an alternative to subpanel 216 in FIG. 2I

In FIG. 2J, a manual option and an upload file option are configured to define devices related with the task item. If the upload file option is selected, then a user is allowed to upload a file that defines the device that is affected by the task item. If the manual option is selected (as shown in FIG. 2J), the user inputs or selects a Network Element ID into a search bar. Further, a target option (i.e., “Target” in FIG. 2J) and an affected option (i.e., “Affected” in FIG. 2J) allow the user to identify whether the device is the target of the task item or whether the device simply is affected by the task item. Once the user has selected the desired network element and specified whether the selected network element is the target of the task item or is simply affected by the task item, the user selects an interactive element (e.g., an “Add” button as illustrated in FIG. 2J) to add the network element to a map presented within the subpanel 216. In some embodiments, when the manual option is selected (as shown in FIG. 2J), the user inputs or selects a keyword associated with the desired devices (e.g., a keyword associated with a device type, a device location, a device labeling, etc.) into a search bar, and the system presents network elements related to the keyword in the map presented within the subpanel 216. Subsequently, the user can select one or more desired network elements from the map. The map locates each device in a designated area and identifies the device with a device name (e.g., “Device 1”, “Device 2). In some embodiments, if the upload file option is selected and the user uploads a file to the system, the system processes the file to retrieve the associated information and present such information in the map shown in the subpanel 216.

In FIG. 2I, buttons named “next” is selectable by a user to move on to the next panel in the GUI 200. A button named “create” is provided to include new devices related to the task. A button named “Cancel” is provided so that a user can cancel any undesired selections.

FIG. 2K is the GUI 200 that includes the panel 214 used to define task items, in accordance with some embodiments.

In FIG. 2K, Template Task Item 1 from FIG. 2F has been selected. Subpanel 216 is configured to allow the user to enter in user input related to basic information for a new task for definition of the task item.

A text bar named “Task Name” is provided that allows a user to enter text for the name of the task item. A text bar named “Description” is provided that allows a user to enter text for a description of the task item.

In FIG. 2K, buttons named “next” is selectable by a user to move on to the next panel in the GUI 200. A button named “create” is provided to create a new task. A button named “Cancel” is provided so that a user can cancel any undesired selections.

FIG. 2L is the GUI 200 that includes the panel 214 used to define task items, in accordance with some embodiments.

In FIG. 2L, Template Task Item 1 from FIG. 2F has been selected. Subpanel 216 is configured to allow the user to enter in devices related task items, as described above with respect to FIG. 2I. More specifically, subpanel 216 allows a user to provide user inputs to select a device (as described above with respect to FIG. 2I) that is associated with the Template Task Item 1.

In FIG. 2L, buttons named “next” is selectable by a user to move on to the next panel in the GUI 200. A button named “create” is provided to include new devices related to the task. A button named “Cancel” is provided so that a user can cancel any undesired selections.

FIG. 2M is the GUI 200 that includes the panel 214 used to indicate requests for change that are each associated with the same template task item, in accordance with some embodiments.

In FIG. 2M, Template Task Item 1 from FIG. 2F has been selected. Panel 214 also shows a selection option named “Template Task Item 1.” Accordingly, each request for change in accordance with “Template Task Item 1” is shown in panel 216 in card view.

In FIG. 2M, buttons named “next” is selectable by a user to move on to the next panel in the GUI 200. A button named “create” is provided to include new change request under Template Task Item 1. A button named “Cancel” is provided so that a user can cancel any undesired selections.

FIG. 2N is the GUI 200 that includes the panel 214 used to define parameters in response to a card being selected in FIG. 2M, in accordance with some embodiments.

In FIG. 2N, a manual option and an upload file option are provided to define parameters related with the task item are included in the subpanel 216. In FIG. 2N, the upload file option is selected and a user is allowed to upload a file that defines parameters and parameter values affected by the task item. In FIG. 2N, the subpanel 216 includes a drag and drop area 217 where a user drops a file that defines parameters (e.g., values, keywords, etc.) for task items.

In FIG. 2N, buttons named “next” is selectable by a user to move on to the next panel in the GUI 200. A button named “create” is provided to include new file with parameters. A button named “Cancel” is provided so that a user can cancel any undesired selections.

In FIG. 2O illustrates an embodiment wherein the manual option (described in relation to FIG. 2N) has been selected. In response to the manual option being selected (as shown in FIG. 2O), the user selects among parameters and enters in parameter values. In FIG. 2O, a list provides entries for parameters. The list identifies the parameters by parameter name (i.e., “Parameter Name” in FIG. 2O). For each entry, the list includes a text box where parameter values are entered for the associated parameter, and includes a check box associated with each of the parameters where the user can select (e.g. by clicking on the check box) which parameters in the list should be included for defining the task item.

In FIG. 2O, buttons named “next” is selectable by a user to move on to the next panel in the GUI 200. A button named “create” is provided to include new file with parameters. A button named “Cancel” is provided so that a user can cancel any undesired selections.

FIG. 3 is a visual representation presented in the GUI 200 of a Request For Change (RFC) structure 300, in accordance with some embodiments.

The RFC structure 300 corresponds with the RFC structure 134 in FIG. 1. The RFC structure 300 includes various data fields including, but not limiting to, a change request identifier (i.e., “ID” in FIG. 3), a change request title (i.e., “Title” in FIG. 3), a ticket number (i.e., “Lab Ticket Number” in FIG. 3), an urgency identifier (i.e., “Urgency” in FIG. 3), a priority identifier (i.e., “Priority” in FIG. 3), a network operation impacted indicator (i.e., “Network Operation Impacted?” in FIG. 3), an impacted services indicator (i.e., “Impacted Services in FIG. 3), an environment indicator (i.e., “Environment” in FIG. 3), an outage duration indicator (i.e., “Outage Duration” in FIG. 3), an escalation contact name indicator (i.e., “Escalation Contact Name” in FIG. 3), an escalation contact number indicator (i.e., “Escalation Contact Phone” in FIG. 3), a change requestor identifier (i.e., “Requestor ID” in FIG. 3), Project Activity or Operational Activity indicator (i.e., “Project Activity or Operational Activity” in FIG. 3), a cause of change request indicator (i.e., “Cause of Change Request” in FIG. 3), a change request type indicator (i.e., “Type” in FIG. 3), an impact indicator (i.e., “Impact” in FIG. 3), an outage requirement indicator (i.e., “Outage Required” in FIG. 3), an impacted subject indicator (i.e., “Impacted Services” in FIG. 3) a task execution mode identifier (i.e., “Task Execution Mode” in FIG. 3), a description of the change request (i.e., Change Request Description” in FIG. 3), an impact access description (i.e., “Impact Assessment” in FIG. 3), an expected result description (i.e., “Expected Result” in FIG. 3). Identifiers for relevant documents are also included in the RFC structure 300.

The ticket number is used to identify testing procedures on the requested change prior to actually implementing the requested change in the network 105, in accordance with some embodiments. In some embodiments, if the change cannot be tested in the testing lab, the exact reasons for the inability to test the network change are indicated in attached documents. In some embodiments, the ticket number is presented in various forms according to the outcome of the testing procedures. For instance, if the requested change is determined to not be acceptable (e.g., the requested change will cause a security issue, the requested change will cause an unacceptable negative impact on the network, etc.) during testing procedures, the ticket number will be presented in red color, which indicates that the RFC structure 300 did not pass the testing procedures. If the requested change is still undergoing testing procedures, the ticket number will be presented in an amber color, which indicates that the RFC structure 300 is still under testing. If the requested change passes the testing procedures, the ticket number will be presented in a green color, which indicates that the RFC structure 300 has passed the testing procedures.

A target automated change request workflow is selected from a plurality of automated change request workflows based on the RFC structure 300. In some embodiments, the broadest categories of automated change request workflows are standard workflows, non-standard workflows, and emergency workflows. Which of these workflows is selected depends at least on the designation provided in the change request type indicator, in accordance with some embodiments. Each of the workflows in these different categories has different procedures, such as different approvers 140 (See FIG. 1) that are to approve a change request. The various workflows fit into different subcategories depending on the data provided in the data fields of the RFC structure 300. For example, different workflows are selected depending on what part of the network 105 the change request is directed to, and/or whether or not the requested change will impact a customer, and the like.

The RFC structure 300 is presented through the GUI 200 so that the change approver 140, the change managers 144, and the change executors 147 review the information on the RFC structure 300. The RFC structure 300 describes the change request. In some embodiments, the GUI 200 includes options that allow for the change approver 140, the change managers 144, and the change executors 147 to change the data in the RFC structure 300. In some embodiments, the GUI 200 includes options for defining the network elements that are affected by the change request, neighboring network elements that are to be affected by the change request, and schedules for network outages and execution of the network changes. Each of these parameters define subcategories for the workflow selected.

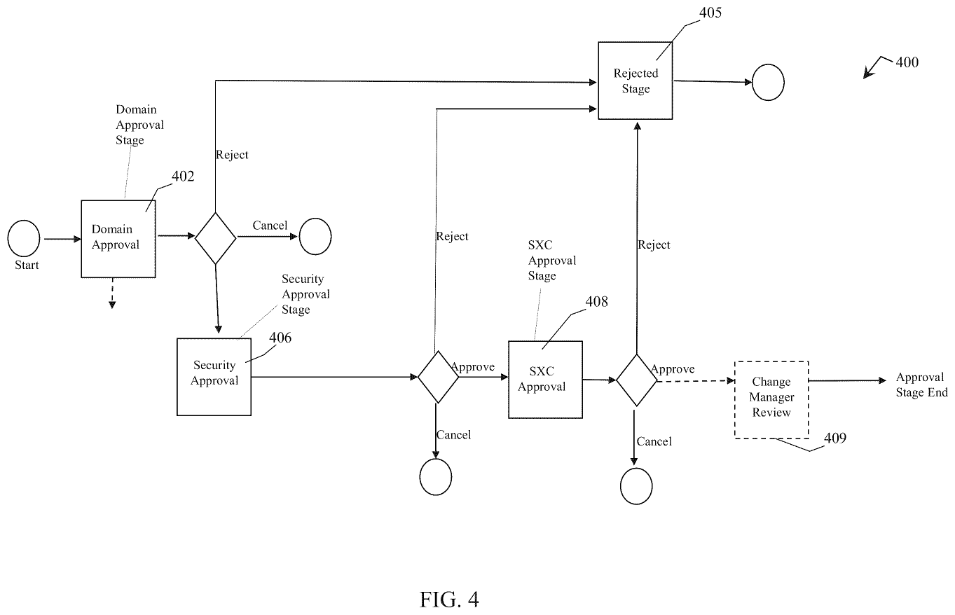

FIG. 4 is a visual representation of a workflow 400, in accordance with some embodiments.

The workflow 400 corresponds with one or more automated change request workflows 152 in FIG. 1. In some embodiments, the workflow 400 is used for standard network changes.

The workflow 400 shown in FIG. 4 relates to approval procedures that are implemented by the change management computer software 127 (See FIG. 1). At block 402, the change management computer software 127 is configured to transmit the RFC structure to a user device of a domain approver. The domain approver is responsible for a particular domain on a network. If the domain approver does not approve the change request described by the RFC structure, the change request described by the RFC structure is canceled and placed into the rejected stage 405. In the rejected stage, the RFC structure is stored with data including reasons for the rejection. In some embodiments, if the domain approver enters in user inputs approving the change request described by the RFC structure, then the change management computer software 127 enters block 406.

At block 406, the change management computer software 127 is configured to transmit the RFC structure to a user device of a security approver. The security approver is responsible for assuring that the requested change complies with the security protocols on the network. If the security approver does not approve the change request described by the RFC structure, the change request described by the RFC structure is canceled and placed into the rejected stage. In the rejected stage, the RFC structure is stored with data including reasons for the rejection. In some embodiments, if the security approver enters in user inputs approving the change request described by the RFC structure, then the change management computer software 127 transmits the RFC structure to an SXC approver at block 408.

At block 408, the change management computer software 127 is configured to transmit the RFC structure to a user device of the SXC approver. If the SXC approver does not approve the change request described by the RFC structure, the change request described by the RFC structure is canceled and placed into the rejected stage 405. In the rejected stage, the RFC structure is stored with data including reasons for the rejection. In some embodiments, if the SXC approver enters in user inputs approving the change request described by the RFC structure, then the change management computer software 127 transmits the RFC structure to one or more change executors 147 since the approval stage has ended.

In other embodiments, if the SXC approver enters in user inputs approving the change request described by the RFC structure, then the change management computer software 127 transmits the RFC structure to the change manager 144 at block 409. In some embodiments, the change manager 144 reviews the RFC structure, as approved by the SXC approver. In some embodiments, the change manager 144 is responsible for reviewing the final approved RFC structure and scheduling the execution of the tasks related to the RF structure (e.g., if the tasks related to the RFC structure should be manually executed, the change manager 144 coordinates with vendors to adjust execution timing and/or priority of the task items). In some embodiments, the change manager 144 then coordinates with third-party contractors (e.g., vendors), if any, and adjust the timing and priority of scheduling based on their coordination with the contractors. After review by the change manager 144, workflow 400 ends. In some embodiments, after the workflow 400 ends, then the change management computer software 127 transmits the RFC structure to one or more change executors 147 for execution of the request for change in accordance with the instructions from the change manager 144.

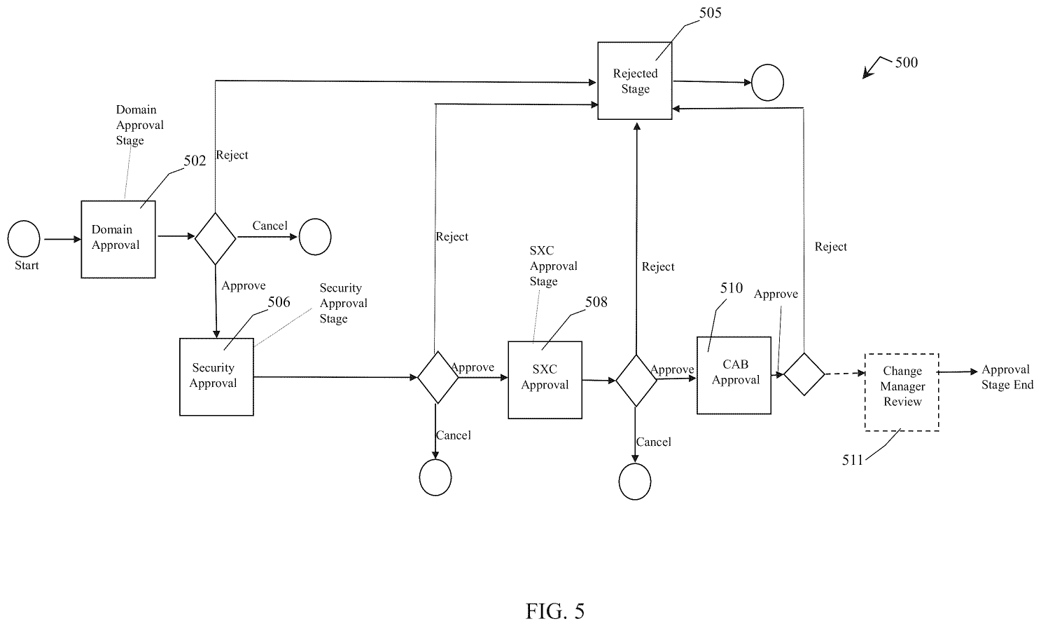

FIG. 5 is a visual representation of a workflow 500, in accordance with some embodiments.

The workflow 500 corresponds with one or more automated change request workflows 152 in FIG. 1. In some embodiments, workflow 500 is used with non-standard type network changes.

The workflow 500 shown in FIG. 5 relates to approval procedures that are implemented by the change management computer software 127 (See FIG. 1). At block 502, the change management computer software 127 is configured to transmit the RFC structure to a user device of a domain approver. The domain approver is responsible for a particular domain on a network. If the domain approver does not approve the change request described by the RFC structure, the change request described by the RFC structure is canceled and placed into the rejected stage 505. In the rejected stage, the RFC structure is reviewed and stored with data including reasons for the rejection. In some embodiments, if the domain approver enters in user inputs approving the change request described by the RFC structure, then the change management computer software 127 enters the RFC structure into the in approval stage at block 504.

At block 506, the change management computer software 127 is configured to transmit the RFC structure to a user device of a security approver. The security approver is responsible for assuring that security protocols are maintained on the network. If the security approver does not approve the change request described by the RFC structure, the change request described by the RFC structure is canceled and placed into the rejected stage. In the rejected stage, the RFC structure is reviewed and stored with data including reasons for the rejection. In some embodiments, if the security approver enters in user inputs approving the change request described by the RFC structure, then the change management computer software 127 transmits the RFC structure to an SXC approver at block 508.

At block 508, the change management computer software 127 is configured to transmit the RFC structure to a user device of the SXC approver. If the SXC approver does not approve the change request described by the RFC structure, the change request described by the RFC structure is canceled and placed into the rejected stage 505. In the rejected stage, the RFC structure is reviewed and stored with data including reasons for the rejection. In some embodiments, if the SXC approver enters in user inputs approving the change request described by the RFC structure, then the change management computer software 127 transmits the RFC structure to a CAB approver at block 510.

At block 510, the change management computer software 127 is configured to transmit the RFC structure to a user device of the CAB approver. The CAB approver is a special body that has been organized to approve non-standard changes. If the CAB approver does not approve the change request described by the RFC structure, the change request described by the RFC structure is canceled and placed into the rejected stage 505. In the rejected stage, the RFC structure is reviewed and stored with data including reasons for the rejection. In some embodiments, if the CAB approver enters in user inputs approving the change request described by the RFC structure, then the change management computer software 127 sends the RFC structure to one or more change executors 147 since the approval stage has ended. In some embodiments, testing procedures are implemented to determine whether the changes to the network were implemented successfully.

In other embodiments, if the CAB approver enters in user inputs approving the change request described by the RFC structure, then the change management computer software 127 transmits the RFC structure to the change manager 144 at block 511. In some embodiments, the change manager 144 reviews the RFC structure, as approved by the CAB approver. In some embodiments, the change manager 144 is responsible for reviewing the final approved RFC structure and scheduling the execution of the tasks related to the RF structure (e.g., if the tasks related to the RFC structure should be manually executed, the change manager 144 coordinates with vendors to adjust execution timing and/or priority of the task items). In some embodiments, the change manager 144 then coordinates with third-party contractors (e.g., vendors), if any, and adjust the timing and priority of scheduling based on their coordination with the contractors. Workflow 500 ends after review by the change manager 144. In some embodiments, after the workflow 500 ends, then the change management computer software 127 transmits the RFC structure to one or more change executors 147 for execution of the request for change in accordance with the instructions from the change manager 144.

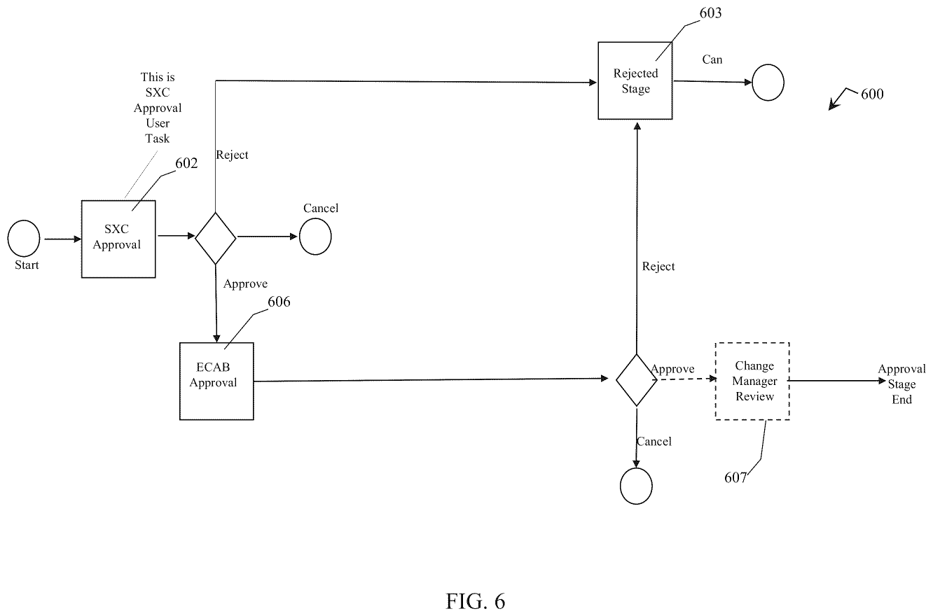

FIG. 6 is a visual representation of a workflow 600, in accordance with some embodiments.

The workflow 600 corresponds with one or more automated change request workflows 152 in FIG. 1. In some embodiments, the workflow 600 is used for emergency network changes.

The workflow 600 shown in FIG. 6 relates to approval procedures that are implemented by the change management computer software 127 (See FIG. 1).

At block 602, the change management computer software 127 is configured to transmit the RFC structure to a user device of the SXC approver. If the SXC approver does not approve the change request described by the RFC structure, the change request described by the RFC structure is canceled and placed into the rejected stage 603. In the rejected stage, the RFC structure is reviewed and stored with data including reasons for the rejection. In some embodiments, the SXC approver enters in user inputs approving the change request described by the RFC structure, then the change management computer software 127 transmits the RFC structure is sent to a CAB approver at block 606.

At block 606, the change management computer software 127 is configured to transmit the RFC structure to a user device of the ECAB approver. The ECAB approver is a special body that has been organized to approve emergency changes. If the ECAB approver does not approve the change request described by the RFC structure, the change request described by the RFC structure is canceled and placed into the rejected stage 603. In the rejected stage, the RFC structure is reviewed and stored with data including reasons for the rejection. In some embodiments, if the ECAB approver enters in user inputs approving the change request described by the RFC structure, then the change management computer software 127 is sent to one or more change executor(s) since the approval stage has ended.

In other embodiments, if the ECAB approver enters in user inputs approving the change request described by the RFC structure, then the change management computer software 127 transmits the RFC structure to the change manager 144 at block 607. In some embodiments, the change manager 144 reviews the RFC structure, as approved by the ECAB approver. In some embodiments, the change manager 144 is responsible for reviewing the final approved RFC structure and scheduling the execution of the tasks related to the RF structure (e.g., if the tasks related to the RFC structure should be manually executed, the change manager 144 coordinates with vendors to adjust execution timing and/or priority of the task items). In some embodiments, the change manager 144 then coordinates with third-party contractors (e.g., vendors), if any, and adjust the timing and priority of scheduling based on their coordination with the contractors. In some embodiments, after the workflow 600 ends, then the change management computer software 127 transmits the RFC structure to one or more change executors 147 for execution of the request for change in accordance with the instructions from the change manager 144.

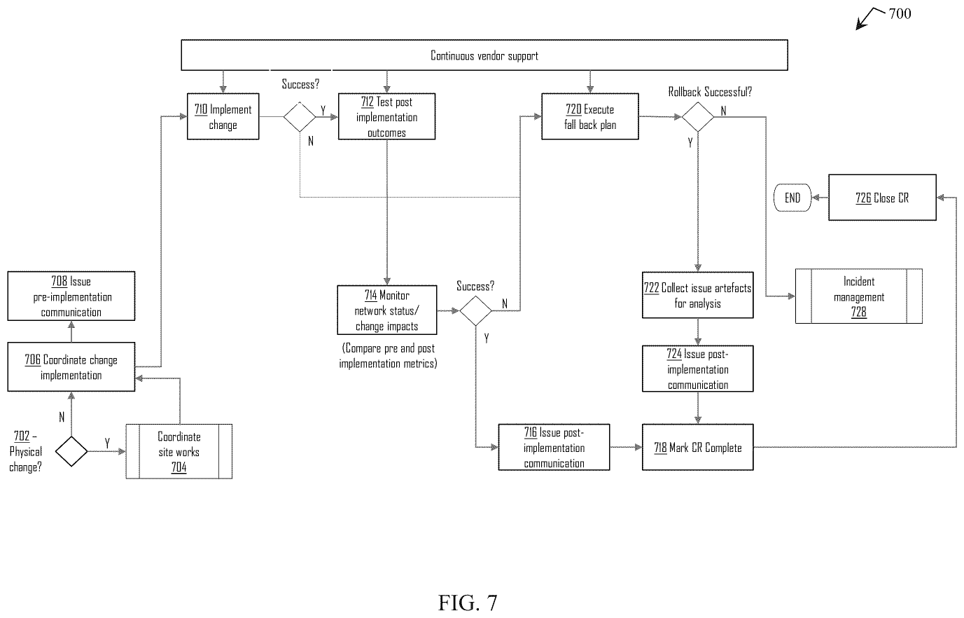

FIG. 7 is a visual representation of a change implementation workflow 700, in accordance with some embodiments.

The change implementation workflow is one embodiment after approved stage 512 in FIG. 5, and approved stage 612 in FIG. 6. In some embodiments, change implementation workflow 700 is a workflow for manually executing non-standard change request.

At block 702, the change management computer software 127 determines whether the change request is for a physical/hardware change or a software change based on the RFC structure.

If the change is a physical/hardware change, the change management computer software 127 transmits a notification to the change manager to coordinate work on-site at block 704. Once on-site work is coordination, the change management computer software 127 sends notification to the change manager to coordinate implementation of the change at block 706.

If the change is not a physical/hardware change, the change management computer software 127 sends notification to the change manager to coordinate implementation of the change at block 706. Regardless of whether the change is physical/hardware or a software change, the change management computer software 127 sends pre-implementation notifications regarding the procedures to be implemented regarding the change to change executors, at block 708. At block 710, the change in the network is implemented. In some embodiments, the change management computer software 127 generate an automated change management task list that includes task items for implementing the change request. The change management computer software 127 schedules the task items on the automated change management task list where notifications of the task items are sent to the user devices of change executors.

If the network change was a success, the change management computer software 127 is configured to coordinate testing procedures are implemented to test network impacts after the outcome at block 712. At block 714, the change management computer software 127 and/or the change executor monitors network status and change impacts (e.g., impacts of the implemented changes on the network, etc). If the test result data regarding the change request indicates that the network change was a success (e.g., there is no change impact or the change impacts are within an acceptable range), the change management computer software 127 issues notifications that the change execution was successful, at block 716. At block 718, the change management computer software 127 marks the change request complete.

If the network change was not successful at block 710 or if network monitoring at block 714 indicates that network testing was not successful and/or the change impact are not within an acceptable range, the change management computer software 127 implements a fallback plan so that the network is provided in the same state that the network was in prior to the network change being implemented at block 720. If the rollback was successful, the change management computer software 127 collects issue artifacts for analysis at block 722. At block 724, the change management computer software 127 issues notifications that the rollback was successful, at block 724. At block 718, the change management computer software 127 marks the change request complete. After block 718, the change request is closed at block 726. If the rollback was not successful, then the change management computer software 127 issues notification regarding incident management at block 728. The notification will be provided to a dedicated team for handling the incident, so that the team can address the issue to reduce the change impact caused by the change execution, or manually rollback the network to the state prior to the change execution.

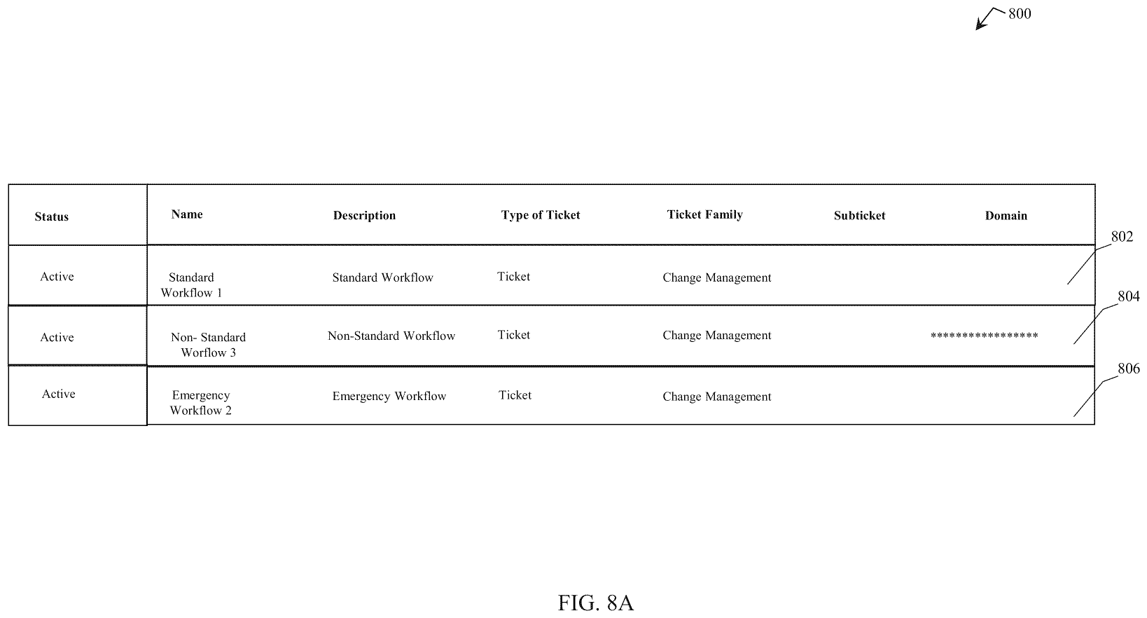

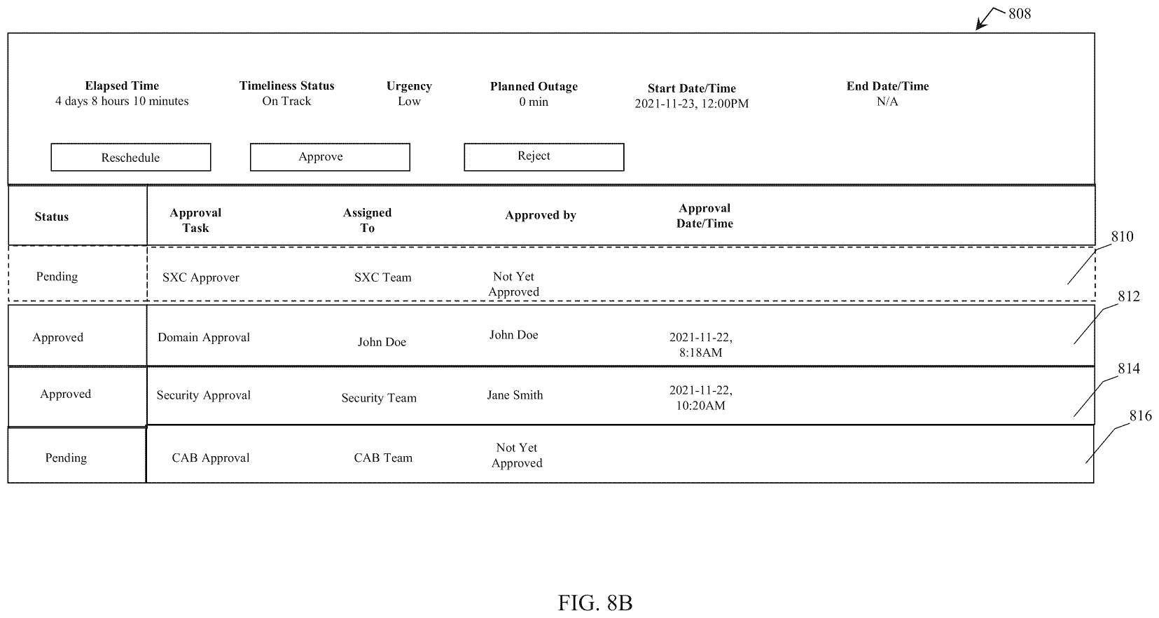

FIG. 8A is a panel 800 of the GUI 200 of a list of RFC structures, in accordance with some embodiments.

The panel 800 includes an entry 802 for a standard workflow of a RFC structure, an entry 804 for a non-standard workflow of a RFC structure, and an entry 806 for an emergency workflow of a RFC structure. By selecting one of the entries 802, 804, 806, the change management computer software 127 is configured to present a visual representation of the RFC structure. A change requestor, change approver, change manager, and a change executor are presented the panel 800 to select among the different RFC structures that are relevant to a particular change request.

FIG. 8B is a panel 808 of the GUI 200 presenting a list of the status of an RFC structure, in accordance with some embodiments.

The panel includes various data fields including, but not limiting to, the amount of time that has elapsed since the request for change has been created. (i.e., “Elapsed Time” in FIG. 8B—once sufficient time has passed, this feature will be shown an overdue), an indicator regarding whether approval process is going as scheduled (e.g., “On Track” is the status of the “Timeliness Status” field in FIG. 8B), an urgency identifier (i.e., “Urgency” in FIG. 8B), an amount of time that an outage on the network is planned (i.e., “Planned Outage” in FIG. 8B), a start date and start time upon which approval was sought (i.e., “Start Date/Time” in FIG. 8B), and an end date and time upon which approval is obtained (i.e., “End Date/Time” in FIG. 8B).

Additionally, a list of the different types of approvals related to the change request is presented. The list includes entries 810, 812, 816, and 818. Each of the entries 810, 812, 816, and 818 includes fields for the type of task being approved (i.e., “Approval Task” in FIG. 8B), who approval is assigned to (i.e., “Assigned To” in FIG. 8B), who gave approval (i.e., “Approved By” in FIG. 3), and an approval date and time (i.e., “Approval Date/Time” in FIG. 8B).

Entry 810 relates to SXC approval and has been selected. In this case, selectable options are provided to an authorized SXC approver to either reschedule the SXC approval for the change request, approve the SXC approval for the change request, or reject the SXC approval for the change request. Entry 812 relates to Domain approval but has not been selected. Entry 814 relates to Security approval but has not been selected. Additionally, entry 816 relates to CAB approval but has not been selected.

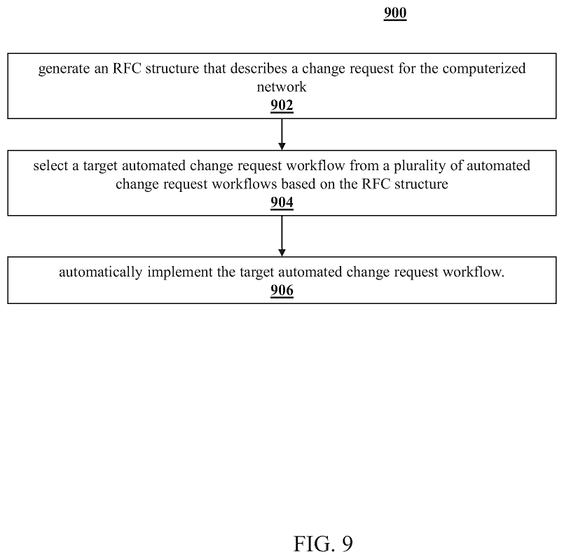

FIG. 9 is a flowchart 900 of a method of implementing changes on a computerized network, in accordance with some embodiments.

Flowchart 900 includes blocks 902-906. Blocks 902-906 are implemented by the change management computer software 127 of the network change management computer device 102 in FIG. 1. Flow begins at block 902.

At block 902, an RFC data structure is generated that describes a change request for the computerized network. Examples of the RFC structure include the RFC structures 134 in FIG. 1 and the RFC structure 300 shown in FIG. 3. Examples of the computerized network include the computer network 105 shown in FIG. 1. Flow then proceeds to block 904.

At block 904, a target automated change request workflow is selected from a plurality of automated change request workflows based on the RFC structure. Examples of the automated change request workflows are the automated change request workflows 152 in FIG. 1, the standard workflow 400 in FIG. 4, the workflow 500 in FIG. 5, and the emergency workflow in FIG. 6. Flow then proceeds to block 906.

At block 906, the target automated change request workflow is automatically implemented.

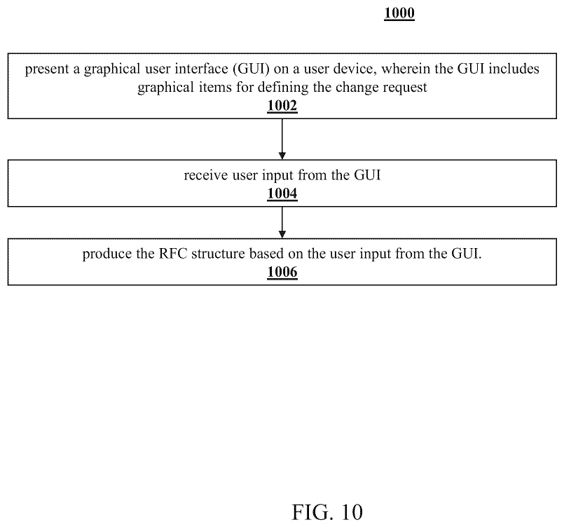

FIG. 10 is a flowchart 1000 of a method of generating the RFC structure, in accordance with some embodiments.

Flowchart 1000 is one embodiment of block 902. Flowchart 1000 includes blocks 1002-1006. Flow begins at block 1002.

At block 1002, a graphical user interface (GUI) is presented on a user device, wherein the GUI includes graphical items for defining the change request. Examples of the GUI include the GUI 200 in FIGS. 2A-2O. Flow then proceeds to block 1004.

At block 1004, user input is received from the GUI.

At block 1006, the RFC structure is produced based on the user input from the GUI. Examples of the RFC structure include the RFC structures 134 in FIG. 1 and the RFC structure 300 shown in FIG. 3. Examples of the computerized network include the computer network 105 shown in FIG. 1.

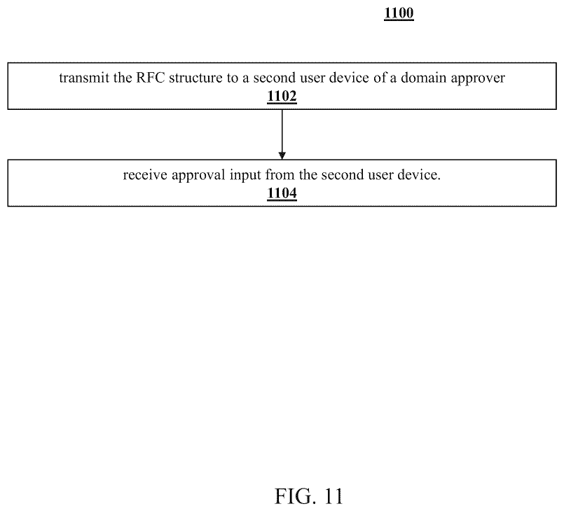

FIG. 11 is a flowchart 1100 that includes implementing the target automated change request workflow, in accordance with some embodiments.

In some embodiments, the flowchart 1100 includes portions of block 906 in FIG. 9. Flowchart 1100 includes blocks 1102-1104. Flow begins at block 1102.

At block 1102, the RFC structure is transmitted to a second user device of a domain approver. Flow then proceeds to block 1104.

At block 1104, the approval input is received from the second user device. Blocks 1102-1104 are implemented at block 502 in FIG. 5.

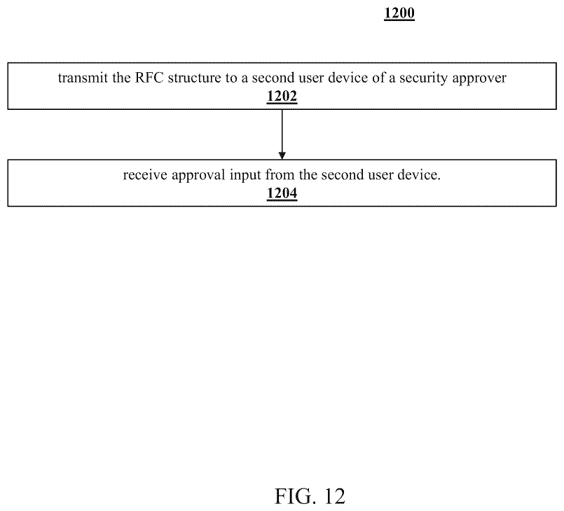

FIG. 12 is a flowchart 1200 that includes implementing the target automated change request workflow, in accordance with some embodiments.

In some embodiments, the flowchart 1200 includes portions of block 906 in FIG. 9. Flowchart 1200 includes blocks 1202-1204. Flow begins at block 1202.

At block 1202, the RFC structure is transmitted to a second user device of a security approver. Flow then proceeds to block 1204.

At block 1204, the approval input is received from the second user device. Blocks 1202-1204 are implemented at block 506 in FIG. 5.

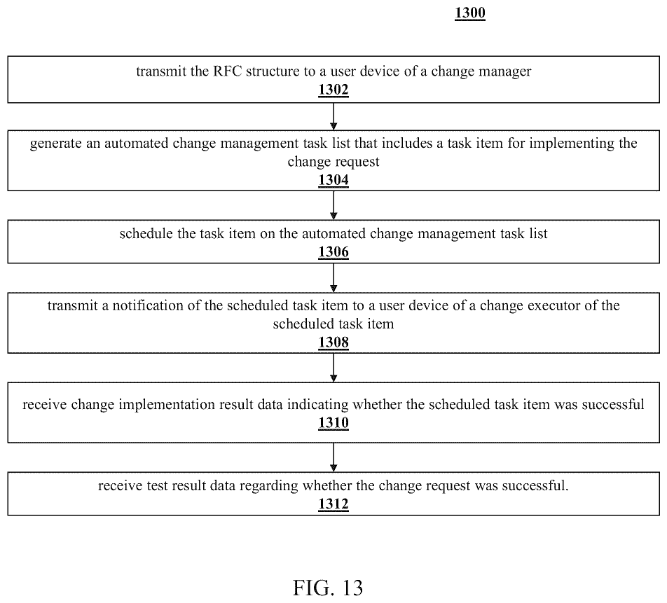

FIG. 13 is a flowchart 1300 that includes implementing the target automated change request workflow, in accordance with some embodiments.

In some embodiments, the flowchart 1300 includes portions of block 906 in FIG. 9. Flowchart 1300 includes blocks 1302-1312. Flow begins at block 1302.

At block 1302, the RFC structure is transmitted to a user device of a change manager. Examples of the user device include user device 111 in FIG. 1. Flow then proceeds to block 1304.

At block 1304, an automated change management task list is generated that includes a task item for implementing the change request. An example of the automated change management task list is used at block 710 of FIG. 7. Flow then proceeds to block 1306.

At block 1306, the task item on the automated change management task list is implemented. An example of the automated change management task list is the change request task list 154 shown in FIG. 1. An example of the automated change management task list is used at block 710 of FIG. 7. Flow then proceeds to block 1308.

At block 1308, a notification of the scheduled task item is transmitted to a user device of a change executor of the scheduled task item. An example of the automated change management task list is used at block 710 of FIG. 7. An example of the user device is user device 111 in FIG. 1. An example of the change executor is change executor 147 in FIG. 1. Flow then proceeds to block 1310.

At block 1310, change implementation result data indicating whether the scheduled task item was successful is received. An example of change implementation result data is change implementation result data 156 in FIG. 1. Change implementation result data is used to determine if the implementation of the network change was successful at block 710 in FIG. 7. Flow then proceeds to block 1312.

At block 1312, test result data is received whether the change request was successful. An example of test result data is test result data 158 in FIG. 1. Test result data is used to determine at block 712-714 in FIG. 7. Flow then proceeds to block 1312.

In some embodiments, a method of implementing changes on a computerized network, includes: generating a request for change data (RFC) structure that describes a change request for the computerized network; selecting a target automated change request workflow from a plurality of automated change request workflows based on the RFC structure; and automatically implementing the target automated change request workflow. In some embodiments, generating the RFC structure includes presenting a graphical user interface (GUI) on a user device, wherein the GUI includes graphical items for defining the change request; receiving user input from the GUI; producing the RFC structure based on the user input from the GUI. In some embodiments, the automatically implementing the target automated change request workflow, includes: transmitting the RFC structure to a second user device of a domain approver; receiving approval input from the second user device. In some embodiments, the automatically implementing the target automated change request workflow, includes: transmitting the RFC structure to a second user device of a security approver; receiving approval input from the second user device. In some embodiments, the RFC structure includes one or more data fields indicating at least one of a type of change, a risk level of the change, a change impact description, suggested scheduling items; and the plurality of automated change request workflows includes a standard network change workflow, a non-standard network change workflow, and an emergency network change workflow; the selecting the target automated change request workflow from the plurality of automated change request workflows is based on the one or more data fields in the RFC structure. In some embodiments, the automatically implementing the target automated change request workflow, includes: transmit the RFC structure to a change manager; generate an automated change management task list that includes a task item for implementing the change request; and scheduling the task item on the automated change management task list. In some embodiments, the automatically implementing the target automated change request workflow further includes: transmitting a notification of the scheduled task item to a change executor of the scheduled task item; receiving change implementation result data indicating whether the scheduled task item was successful. In some embodiments, the automatically implementing the target automated change request workflow further includes: receiving test result data regarding whether the change request was successful.

In some embodiments, a computer device for implementing changes on a computerized network, includes: at least one processor; a non-transitory computer readable medium that stores computer executable instructions, wherein, when the at least one processor executes the computer executable instructions, the at least one processor is configured to: generate a request-for-change data (RFC) structure that describes a change request for the computerized network; select a target automated change request workflow from a plurality of automated change request workflows based on the RFC structure; and automatically implement the target automated change request workflow. In some embodiments, generating the RFC structure includes: presenting a graphical user interface (GUI) on a user device, wherein the GUI includes graphical items for defining the change request; receiving user input from the GUI; producing the RFC structure based on the user input from the GUI. In some embodiments, the at least one processor is configured to automatically implement the target automated change request workflow by: transmitting the RFC structure to a second user device of a domain approver; receiving approval input from the second user device. In some embodiments, the at least one processor is configured to automatically implement the target automated change request workflow by: transmit the RFC structure to a second user device of a security approver; receive approval input from the second user device. In some embodiments, the RFC structure includes one or more data fields indicating at least one of a type of change, a risk level of the change, a change impact description, suggested scheduling items; and the plurality of automated change request workflows includes a standard network change workflow, a non-standard network change workflow, and an emergency network change workflow; the selecting the target automated change request workflow from the plurality of automated change request workflows is based on the one or more data fields in the RFC structure. In some embodiments, the automatically implementing the target automated change request workflow, includes: transmit the RFC structure to a change manager; generate an automated change management task list that includes a task item for implementing the change request; and scheduling the task item on the automated change management task list. In some embodiments, the automatically implementing the target automated change request workflow further includes: transmitting a notification of the scheduled task item to a change executor of the scheduled task item; receiving change implementation result data indicating whether the scheduled task item was successful. In some embodiments, the automatically implementing the target automated change request workflow further includes: receiving test result data regarding whether the change request was successful.

In some embodiments, a non-transitory computer readable medium that stores computer executable instructions, wherein, when at least one processor executes the computer executable instructions, the at least one processor is configured to: generate a request-for-change data (RFC) structure that describes a change request for the computerized network; select a target automated change request workflow from a plurality of automated change request workflows based on the RFC structure; and automatically implement the target automated change request workflow. In some embodiments, generating the RFC structure includes: presenting a graphical user interface (GUI) on a user device, wherein the GUI includes graphical items for defining the change request; receiving user input from the GUI; producing the RFC structure based on the user input from the GUI. In some embodiments, the at least one processor is configured to automatically implement the target automated change request workflow by: transmitting the RFC structure to a second user device of a domain approver; receiving approval input from the second user device. In some embodiments, the at least one processor is configured to automatically implement the target automated change request workflow by: transmit the RFC structure to a second user device of a security approver; receive approval input from the second user device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

What is claimed is:

1. A method of implementing changes on a computerized network, comprising:
generating a request-for-change data (RFC) structure that describes a change request for the computerized network;
selecting a target automated change request workflow from a plurality of automated change request workflows based on the RFC structure; and
automatically implementing the target automated change request workflow.

2. The method of claim 1, wherein generating the RFC structure comprises:
presenting a graphical user interface (GUI) on a user device, wherein the GUI includes graphical items for defining the change request;
receiving user input from the GUI;
generating the RFC structure based on the user input from the GUI.

3. The method of claim 2, wherein the automatically implementing the target automated change request workflow, comprises:
transmitting the RFC structure to a second user device of a domain approver;
receiving approval input from the second user device.

4. The method of claim 2, wherein the automatically implementing the target automated change request workflow, comprises:
transmitting the RFC structure to a second user device of a security approver;
receiving approval input from the second user device.

5. The method of claim 1, wherein:
the RFC structure includes one or more data fields indicating at least one of a type of change, a risk level of the change, a change impact description, suggested scheduling items; and
the selecting the target automated change request workflow from the plurality of automated change request workflows is based on the one or more data fields in the RFC structure.

6. The method of claim 1, wherein the automatically implementing the target automated change request workflow, comprises:
transmit the RFC structure to a change manager;
generate an automated change management task list that includes a task item for implementing the change request; and
scheduling the task item on the automated change management task list.

7. The method of claim 6, wherein the automatically implementing the target automated change request workflow further comprises:
transmitting a notification of the scheduled task item to a change executor of the scheduled task item;
receiving change implementation result data indicating whether the scheduled task item was successful.

8. The method of claim 7, wherein the implementing the target automated change request workflow further comprises:
receiving test result data regarding whether the change request was successful.

9. A computer device for implementing changes on a computerized network, comprising:
at least one processor;
a non-transitory computer readable medium that stores computer executable instructions, wherein, when the at least one processor executes the computer executable instructions, the at least one processor is configured to:
generate a request-for-change data (RFC) structure that describes a change request for the computerized network;
select a target automated change request workflow from a plurality of automated change request workflows based on the RFC structure; and
automatically implement the target automated change request workflow.

10. The computer device of claim 9, wherein generating the RFC structure comprises:
presenting a graphical user interface (GUI) on a user device, wherein the GUI includes graphical items for defining the change request;
receiving user input from the GUI;
producing the RFC structure based on the user input from the GUI.

11. The computer device of claim 10, wherein the at least one processor is configured to automatically implement the target automated change request workflow by:
transmitting the RFC structure to a second user device of a domain approver;
receiving approval input from the second user device.

12. The computer device of claim 10, wherein the at least one processor is configured to automatically implement the target automated change request workflow by:
transmit the RFC structure to a second user device of a security approver;
receive approval input from the second user device.

13. The computer device of claim 9, wherein:
the RFC structure includes one or more data fields indicating at least one of a type of change, a risk level of the change, a change impact description, suggested scheduling items; and
the selecting the target automated change request workflow from the plurality of automated change request workflows is based on the one or more data fields in the RFC structure.

14. The computer device of claim 9, wherein the automatically implementing the target automated change request workflow, comprises:
transmit the RFC structure to a change manager;
generate an automated change management task list that includes a task item for implementing the change request; and
scheduling the task item on the automated change management task list.

15. The computer device of claim 14, wherein the automatically implementing the target automated change request workflow further comprises:
transmitting a notification of the scheduled task item to a change executor of the scheduled task item;
receiving change implementation result data indicating whether the scheduled task item was successful.

16. The computer device of claim 15, wherein the automatically implementing the target automated change request workflow further comprises:
receiving test result data regarding whether the change request was successful.

17. A non-transitory computer readable medium that stores computer executable instructions, wherein, when at least one processor executes the computer executable instructions, the at least one processor is configured to:
generate a request-for-change data (RFC) structure that describes a change request for the computerized network;
select a target automated change request workflow from a plurality of automated change request workflows based on the RFC structure; and
automatically implement the target automated change request workflow.

18. The non-transitory computer readable medium of claim 17, wherein generating the RFC structure comprises:
presenting a graphical user interface (GUI) on a user device, wherein the GUI includes graphical items for defining the change request;
receiving user input from the GUI;
producing the RFC structure based on the user input from the GUI.

19. The non-transitory computer readable medium of claim 18, wherein the at least one processor is configured to automatically implement the target automated change request workflow by:
transmitting the RFC structure to a second user device of a domain approver;
receiving approval input from the second user device.

20. The non-transitory computer readable medium of claim 19, wherein the at least one processor is configured to automatically implement the target automated change request workflow by:
transmit the RFC structure to a second user device of a security approver;
receive approval input from the second user device.
